(19) United States
(12) Patent Application Publication
(10) Pub. No.: US 2026/0082373 A1
(43) Pub. Date: Mar. 19, 2026

(54) CONFIGURING A FIRST COMMUNICATION CHAIN FOR A BANDWIDTH PART CHANGE WITHOUT MODIFYING A SECOND COMMUNICATION CHAIN

(71) Applicant: QUALCOMM Incorporated, San Diego, CA (US)

(72) Inventors: Raveesh JUNEJA, Hyderabad (IN); Kianoush HOSSEINI, San Diego, CA (US)

(21) Appl. No.: 18/888,630

(22) Filed: Sep. 18, 2024

(51) Int. Cl. H04W 72/0453

(52) U.S. Cl. CPC H04W 72/0453

(57) ABSTRACT

Various aspects of the present disclosure generally relate to wireless communication. In some aspects, a user equipment (UE) may transmit UE capability information that indicates support for independently modifying a bandwidth part (BWP) configuration of a first communication chain that is configured with a first BWP in a carrier without modifying a second communication chain that is configured with a second BWP in the carrier. The UE may receive, based at least in part on indicating support for independently modifying the BWP configuration of the first communication chain without modifying the second communication chain, an instruction to reconfigure the first communication chain with a third BWP in the carrier without modifying the second communication chain. Numerous other aspects are described.

### FIELD OF THE DISCLOSURE

Aspects of the present disclosure generally relate to wireless communication and specifically relate to techniques, apparatuses, and methods for configuring a first communication chain for a bandwidth part change without modifying a second communication chain.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include transmitting UE capability information that indicates support for independently modifying a bandwidth part (BWP) configuration of a first communication chain that is configured with a first BWP in a carrier without modifying a second communication chain that is configured with a second BWP in the carrier. The method may include receiving, based at least in part on indicating support for independently modifying the BWP configuration of the first communication chain without modifying the second communication chain, an instruction to reconfigure the first communication chain with a third BWP in the carrier without modifying the second communication chain.

Some aspects described herein relate to a method of wireless communication performed by a network node. The method may include receiving UE capability information that indicates support for independently modifying a BWP configuration of a first communication chain that is configured with a first BWP in a carrier without modifying a second communication chain that is configured with a second BWP in the carrier. The method may include transmitting, based at least in part on receiving an indication of the support for independently modifying the BWP configuration of the first communication chain without modifying the second communication chain, an instruction to reconfigure the first communication chain with a third BWP in the carrier without modifying the second communication chain.

Some aspects described herein relate to an apparatus for wireless communication at a UE. The apparatus may include one or more memories and one or more processors coupled to the one or more memories. The one or more processors may be configured to transmit UE capability information that indicates support for independently modifying a BWP configuration of a first communication chain that is configured with a first BWP in a carrier without modifying a second communication chain that is configured with a second BWP in the carrier. The one or more processors may be configured to receive, based at least in part on indicating support for independently modifying the BWP configuration of the first communication chain without modifying the second communication chain, an instruction to reconfigure the first communication chain with a third BWP in the carrier without modifying the second communication chain.

Some aspects described herein relate to an apparatus for wireless communication at a network node. The apparatus may include one or more memories and one or more processors coupled to the one or more memories. The one or more processors may be configured to receive UE capability information that indicates support for independently modifying a BWP configuration of a first communication chain that is configured with a first BWP in a carrier without modifying a second communication chain that is configured with a second BWP in the carrier. The one or more processors may be configured to transmit, based at least in part on receiving an indication of the support for independently modifying the BWP configuration of the first communication chain without modifying the second communication chain, an instruction to reconfigure the first communication chain with a third BWP in the carrier without modifying the second communication chain.

Some aspects described herein relate to a non-transitory computer-readable medium that stores a set of instructions for wireless communication by a UE. The set of instructions, when executed by one or more processors of the UE, may cause the UE to transmit UE capability information that indicates support for independently modifying a BWP configuration of a first communication chain that is configured with a first BWP in a carrier without modifying a second communication chain that is configured with a second BWP in the carrier. The set of instructions, when executed by one or more processors of the UE, may cause the UE to receive, based at least in part on indicating support for independently modifying the BWP configuration of the first communication chain without modifying the second communication chain, an instruction to reconfigure the first communication chain with a third BWP in the carrier without modifying the second communication chain.

Some aspects described herein relate to a non-transitory computer-readable medium that stores a set of instructions for wireless communication by a network node. The set of instructions, when executed by one or more processors of the network node, may cause the network node to receive UE capability information that indicates support for independently modifying a BWP configuration of a first communication chain that is configured with a first BWP in a carrier without modifying a second communication chain that is configured with a second BWP in the carrier. The set of instructions, when executed by one or more processors of the network node, may cause the network node to transmit, based at least in part on receiving an indication of the support for independently modifying the BWP configuration of the first communication chain without modifying the second communication chain, an instruction to reconfigure the first communication chain with a third BWP in the carrier without modifying the second communication chain.

Some aspects described herein relate to an apparatus for wireless communication. The apparatus may include means for transmitting UE capability information that indicates support for independently modifying a BWP configuration of a first communication chain that is configured with a first BWP in a carrier without modifying a second communication chain that is configured with a second BWP in the carrier. The apparatus may include means for receiving, based at least in part on indicating support for independently modifying the BWP configuration of the first communication chain without modifying the second communication chain, an instruction to reconfigure the first communication chain with a third BWP in the carrier without modifying the second communication chain.

Some aspects described herein relate to an apparatus for wireless communication. The apparatus may include means for receiving UE capability information that indicates support for independently modifying a BWP configuration of a first communication chain that is configured with a first BWP in a carrier without modifying a second communication chain that is configured with a second BWP in the carrier. The apparatus may include means for transmitting, based at least in part on receiving an indication of the support for independently modifying the BWP configuration of the first communication chain without modifying the second communication chain, an instruction to reconfigure the first communication chain with a third BWP in the carrier without modifying the second communication chain.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a bandwidth part (BWP), in accordance with the present disclosure.

FIGS. 5A, 5B, and 5C are diagrams illustrating a first example, a second example, and a third example, respectively, of independent BWP switching, in accordance with the present disclosure.

FIGS. 6A and 6B are diagrams illustrating a first example and a second example of independent BWP switching based at least in part on carrier aggregation, in accordance with the present disclosure.

FIG. 7 is a diagram illustrating an example of independent BWP switching that is based at least in part on dual subscriber identity module dual modes, in accordance with the present disclosure.

FIG. 8 is a diagram illustrating an example of a wireless communication process between a network node and a UE, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless communication channel, alternatively referred to as a carrier, may be based at least in part on a center frequency, a frequency bandwidth, and/or a set of resource blocks (RBs), and a bandwidth part (BWP) may denote a subset of contiguous RBs (and/or resource elements (REs)) within the set of RBs associated with a carrier, and a carrier may be partitioned into multiple BWPs. The ability to partition the carrier into BWPs may provide flexibility and efficient usage of the bandwidth associated with the carrier.

At times, a network node may reconfigure a BWP that is used by a user equipment (UE), such as by reconfiguring the BWP to adapt to current network conditions, to meet a quality-of-service (QoS) requirement, to adapt to communication channel changes, and/or to adapt to spectrum availability. A BWP switch may be governed by one or more operating criteria, such as a delay operating criterion and/or a timing operating criterion that the network node and/or the UE may be obligated to fulfill in order to operate in a wireless network. In some scenarios, a carrier may be partitioned into multiple BWPs, and a first BWP in the carrier may be linked to a second BWP in the carrier. To illustrate, a network node may configure a UE with a set of downlink BWP configurations and a set of uplink BWP configurations within the carrier by indicating the set of downlink BWP configurations and/or a set of uplink BWP configurations in radio resource control (RRC) signaling. Each downlink BWP configuration may be associated with a respective index and/or a BWP identifier (ID), and the respective index and/or BWP ID may be linked to a respective uplink BWP configuration. At a later point in time, the network node may indicate to switch BWPs and/or BWP configurations by indicating an index and/or BWP ID to the UE.

In some cases the UE may interpret a BWP switch instruction as an instruction to configure all of the linked BWPs. For instance, the UE may receive a BWP switch instruction that indicates to switch a downlink BWP configuration, and the instruction may indicate an index and/or BWP ID of the BWP configuration to use in reconfiguring a downlink communication chain. The UE may interpret the BWP switch instruction as an instruction to switch both a downlink BWP configuration and an uplink BWP configuration based at least in part on the index and/or BWP ID being linked to multiple BWP configurations.

“Joint BWP switching” may denote a UE reconfiguring each communication chain of multiple communication chain with a respective BWP configuration together and/or during a same switching duration based at least in part on a linkage between the BWP configurations. To illustrate the UE may reconfigure a first communication chain (e.g., a downlink communication chain and/or a receiver communication chain) using a first BWP configuration and may reconfigure a second communication chain (e.g., an uplink communication chain and/or a transmitter communication chain) using a second BWP configuration that is linked to the first BWP configuration. In some cases, joint BWP switching may result in performance degradation in a wireless system, such as increased data transfer latencies, reduced data throughput, and/or sub-optimal air interface resource usage. For instance, the network node may instruct the UE to perform a BWP switch using a first BWP configuration that the network node selected to be optimized for downlink communications, and the first BWP configuration may be linked to a second BWP configuration that is sub-optimal for uplink communications. As one example, a downlink data traffic pattern may differ from an uplink data traffic pattern, and the network node may select a downlink BWP configuration based at least in part on the downlink data traffic pattern. However, the linked uplink BWP configuration may be sub-optimal for the uplink data pattern and, based at least in part on performing joint BWP switching, the UE may reconfigure a transmitter communication chain and/or an uplink communication chain using the (linked) sub-optimal BWP configuration. The sup-optimal BWP configuration may result sub-optimal bandwidth usage and/or sub-optimal air interface resource usage by the UE and, consequently, air interface resource waste. As another example, the network node may trigger a BWP switch based at least in part on downlink communications, and the joint BWP switching may unnecessarily introduce a latency in uplink communications that introduces a delay in time-sensitive applications and may result in a failure to meet a time-based operating condition and/or a QoS operating condition.

Various aspects relate generally to configuring a first communication chain for a BWP change without modifying a second communication chain. Some aspects more specifically relate to a UE configuring the first communication chain to use an updated BWP, and maintaining, in parallel, communications on the second communication chain (e.g., not performing blanking on the second communication chain). In some aspects, a UE may transmit UE capability information that indicates support for independently modifying a BWP configuration of a first communication chain that is configured with a first BWP in a carrier without modifying a second communication chain that is configured with a second BWP in the carrier. In some aspects, the first communication chain may be a receiver communication chain (e.g., for processing a downlink signal and/or a first sidelink signal) and the second communication chain may be a transmitter communication (e.g., for processing an uplink signal and/or a second sidelink signal), or vice versa. Based at least in part on indicating support for independently modifying the BWP configuration of the first communication chain without modifying the second communication chain, the UE may receive an instruction to reconfigure the first communication chain to a third BWP in the carrier without modifying the second communication chain. That is, the instruction may indicate to only reconfigure the first communication chain. In some aspects, the UE may use the second communication chain while reconfiguring the first communication chain, resulting in reduced data transfer latencies relative to joint BWP switching.

In some aspects, a network node may receive UE capability information that indicates support for independently modifying a BWP configuration of a first communication chain that is configured with a first BWP in a carrier without modifying a second communication chain that is configured with a second BWP in the carrier. Based at least in part on receiving the indication of the support for independently modifying the BWP configuration of the first communication chain without modifying the second communication chain, the network node may transmit an instruction to reconfigure the first communication chain with a third BWP in the carrier without modifying the second communication chain. That is, the instruction may indicate to only modify the first communication chain and/or may not indicate to modify the second communication chain. In some aspects, the network node may transmit the instruction based at least in part on a scheduling pattern. To illustrate, the network node may leverage an uplink time partition by instructing the UE to reconfigure a downlink communication chain during at least part of the uplink time partition.

Particular aspects of the subject matter described in this disclosure can be implemented to realize one or more of the following potential advantages. In some examples, by using independent BWP switching for multiple communication chains (e.g., instead of using joint BWP switching), the described techniques can be used to enable a network node to leverage a scheduling pattern and instruct a UE to reconfigure a first communication chain during a time partition that is associated with a second communication chain. For example, the network node may instruct a UE to reconfigure a BWP of a downlink communication chain during an uplink time partition (e.g., a time partition in which the downlink communication chain will be unused) to reduce data transfer latencies and/or increase data throughput of the downlink chain (or vice versa). The use of independent BWP switching may also enable the network node to select unlinked BWP configurations for each communication chain used by a UE and/or select respective BWP configurations that are optimized for the communication chain. For instance, the network node may select a first downlink BWP configuration that reduces air interface resource waste based at least in part on a downlink data traffic pattern and/or may select a second BWP configuration (e.g., that is not linked to the first BWP configuration) that reuses air interface resource waste based at least in part on an uplink data traffic pattern. Alternatively, or additionally, the network node may select each BWP configuration to reduce a respective data transfer latency and/or satisfy a QoS operating condition. Mitigating air interface resources waste may reduce data transfer latencies and/or increase data throughput.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing. Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial platforms, among other examples. The methods, operations, apparatuses, and techniques described herein may enable one or more of the foregoing technologies and/or support one or more of the foregoing use cases.

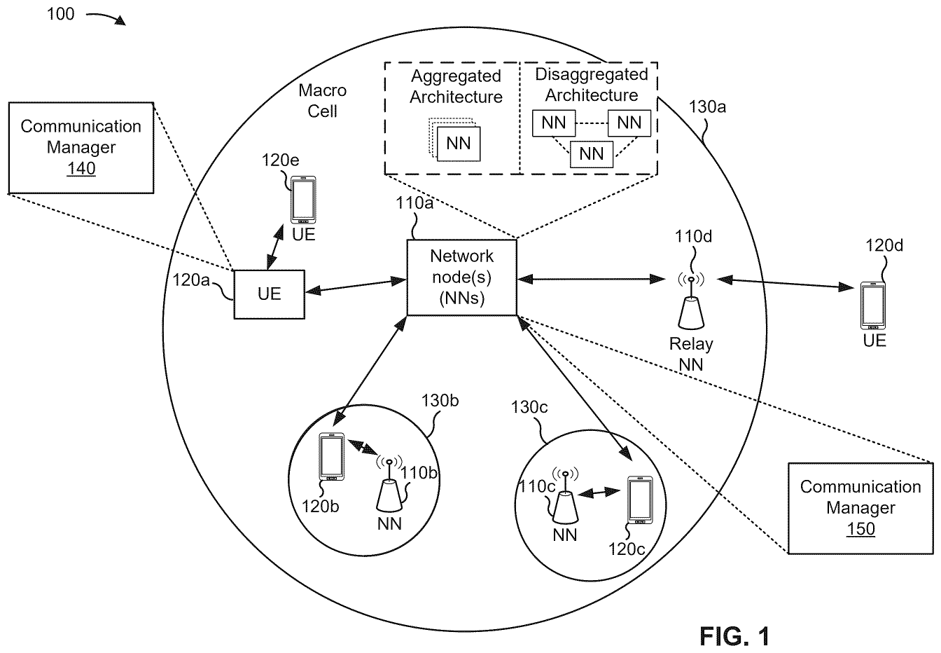

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHZ through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2. FR4, FR4-a or FR4-1, or FR5, and/or that are within the EHF band. Higher frequency bands may extend 5G NR operation, 6G operation, and/or other RATs beyond 52.6 GHZ. For example, each of FR4a. FR4-1. FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a. FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40) watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into BWPs. A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry.”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, a remote device, a sensor, a meter, a monitor, and/or a location tag. Some UEs 120 may be considered IoT devices and/or may be implemented as NB-IoT (narrow band IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., a UE 120) may include a communication manager 140. As described in more detail elsewhere herein, the communication manager 140 may transmit UE capability information that indicates support for independently modifying a BWP configuration of a first communication chain that is configured with a first BWP in a carrier without modifying a second communication chain that is configured with a second BWP in the carrier; and receive, based at least in part on indicating support for independently modifying the BWP configuration of the first communication chain without modifying the second communication chain, an instruction to reconfigure the first communication chain with a third BWP in the carrier without modifying the second communication chain. Additionally, or alternatively, the communication manager 140 may perform one or more other operations described herein.

In some aspects, a network node (e.g., a network node 110) may include a communication manager 150. As described in more detail elsewhere herein, the communication manager 150 may receive UE capability information that indicates support for independently modifying a BWP configuration of a first communication chain that is configured with a first BWP in a carrier without modifying a second communication chain that is configured with a second BWP in the carrier; and transmit, based at least in part on receiving an indication of the support for independently modifying the BWP configuration of the first communication chain without modifying the second communication chain, an instruction to reconfigure the first communication chain with a third BWP in the carrier without modifying the second communication chain. Additionally, or alternatively, the communication manager 150 may perform one or more other operations described herein.

As indicated above, FIG. 1 is provided as an example. Other examples may differ from what is described with regard to FIG. 1.

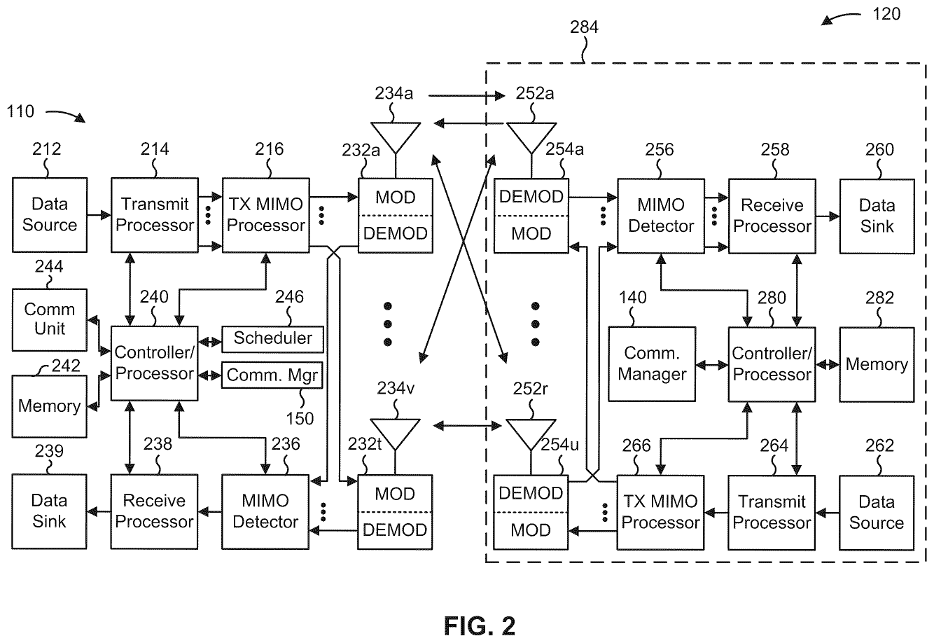

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, (output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein. “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

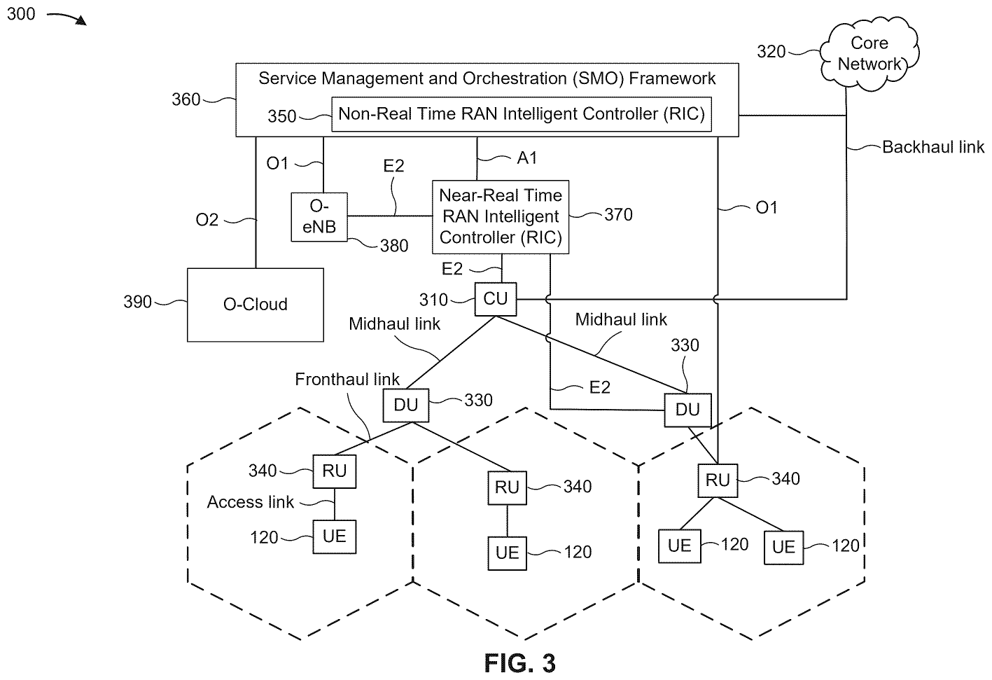

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

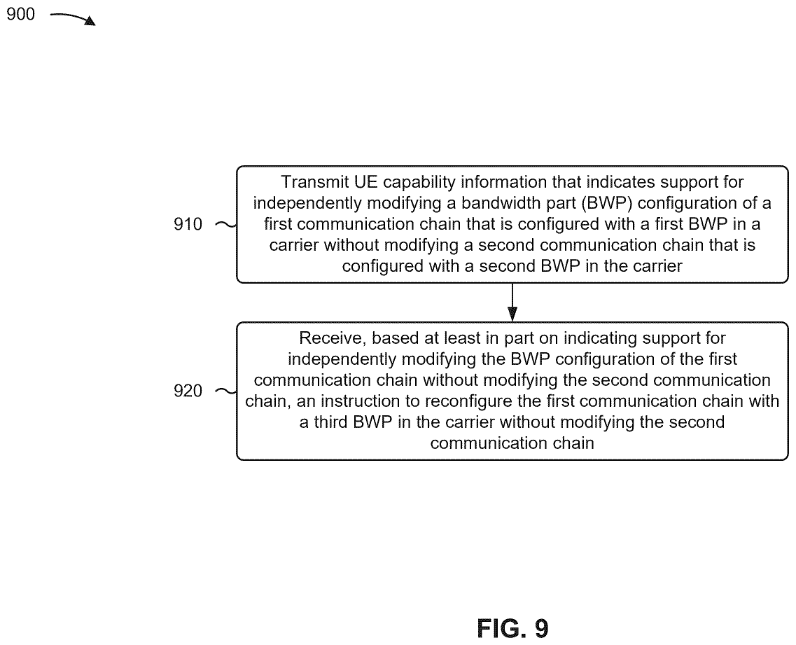

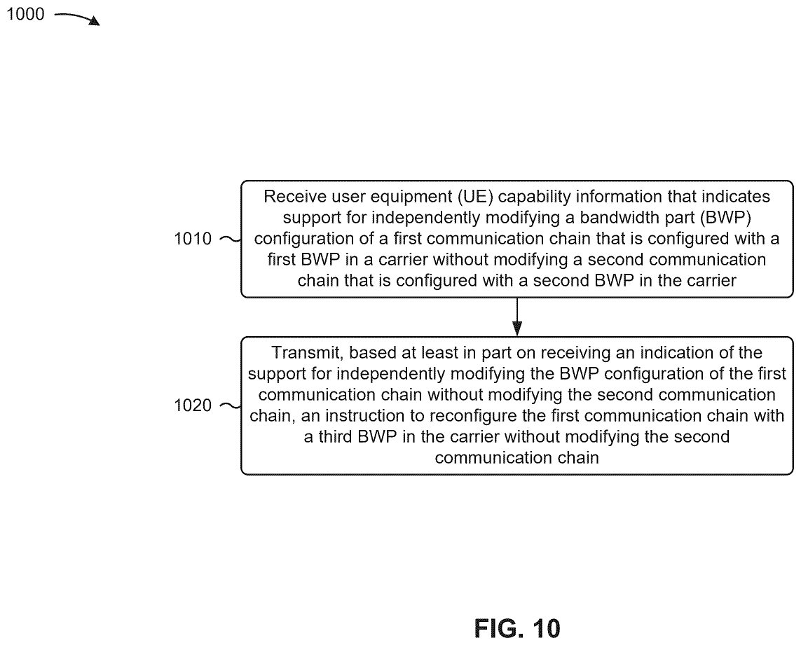

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with configuring a first communication chain for a bandwidth part change without modifying a second communication chain, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, a UE (e.g., a UE 120) includes means for transmitting UE capability information that indicates support for independently modifying a BWP configuration of a first communication chain that is configured with a first BWP in a carrier without modifying a second communication chain that is configured with a second BWP in the carrier; and/or means for receiving, based at least in part on indicating support for independently modifying the BWP configuration of the first communication chain without modifying the second communication chain, an instruction to reconfigure the first communication chain with a third BWP in the carrier without modifying the second communication chain. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., a network node 110) includes means for receiving UE capability information that indicates support for independently modifying a BWP configuration of a first communication chain that is configured with a first BWP in a carrier without modifying a second communication chain that is configured with a second BWP in the carrier; and/or means for transmitting, based at least in part on receiving an indication of the support for independently modifying the BWP configuration of the first communication chain without modifying the second communication chain, an instruction to reconfigure the first communication chain with a third BWP in the carrier without modifying the second communication chain. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

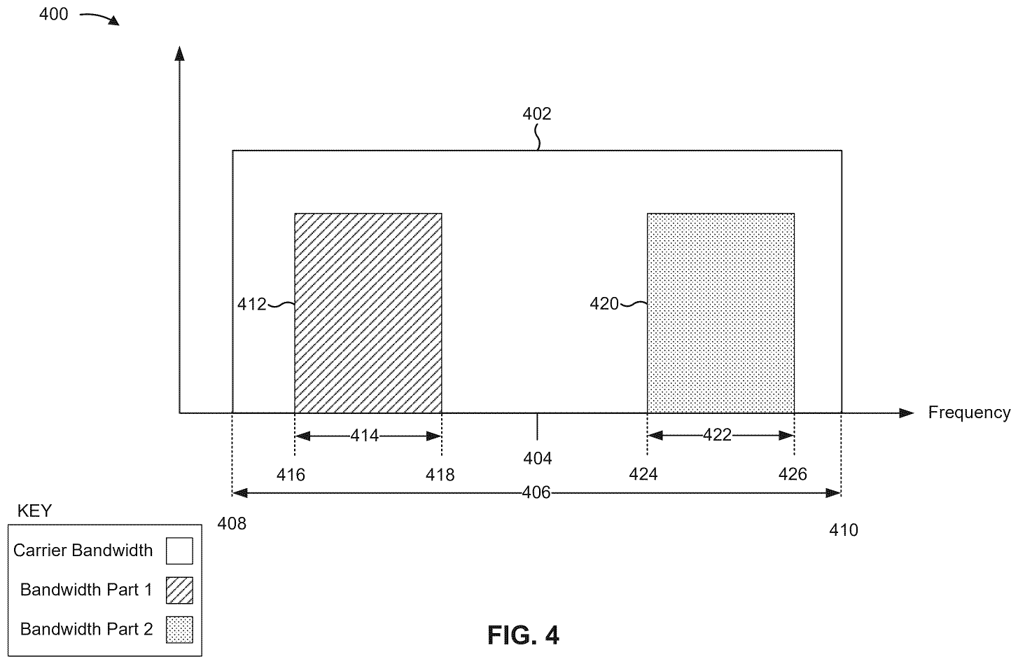

FIG. 4 is a diagram illustrating an example 400 of a BWP, in accordance with the present disclosure.

In some aspects, a wireless communication channel, alternatively referred to as a “carrier”, may be based at least in part on a center frequency, a frequency bandwidth, and or a set of RBs. To illustrate, a carrier 402 (shown in solid white) may be based at least in part on a center frequency 404 (e.g., a carrier frequency) and a frequency bandwidth 406. The frequency bandwidth 406 of the carrier 402 may be based at least in part on a first edge frequency 408 and a second edge frequency 410. Each RB of the carrier may include a group of REs that are characterized by a frequency partition and a time partition. Accordingly, the set of RBs associated with the carrier 402 may collectively span a bandwidth (e.g., the frequency bandwidth 406) and time duration.

A “bandwidth part” (or “BWP”) may denote a subset of contiguous RBs (and/or REs) within the set of RBs associated with a carrier, and a carrier may be partitioned into multiple BWPs (e.g., four). The ability to partition the carrier into BWPs may provide flexibility and efficient usage of the bandwidth associated with the carrier. To illustrate, the frequency bandwidth 406 may span 100 MHz and may be referred to as a wideband channel. Some UEs, such as an IoT device and/or a reduced capacity (RedCap) device, may lack capabilities that support wideband communications. For example, an IoT device may lack a transceiver with capabilities to transmit and/or receive a wideband signal. Alternatively or additionally, the IoT device may lack a processor with capabilities to process digital samples associated with the wideband signal in real-time. Accordingly, a network node may partition a carrier into one or more BWPs for communicating with the IoT and/or other types of UEs. To illustrate, the network node may select and/or configure a first BWP 412 (shown by a diagonal line hash pattern) within the carrier 402 based at least in part on a frequency bandwidth 414, a first frequency edge 416, and a second frequency edge 418. The network node may select and/or configure a second BWP 420 (shown by a dotted pattern) within the carrier 402 based at least in part on a frequency bandwidth 422, a first frequency edge 424, and a second frequency edge 426. The network node May select a preconfigured BWP (e.g., defined by a communication standard) and/or may dynamically configure a BWP (e.g., dynamically select a bandwidth and/or a frequency edge)

Although the example 400 shows the first BWP 412 and the second BWP 420 as having equal bandwidths and being positioned symmetrically within the carrier 402, other examples may include BWPs in a same carrier that have different characteristics (e.g., frequency bandwidths). To illustrate, the first BWP 412 may be configured with a larger bandwidth relative to the second BWP 420 based at least in part on the first BWP 412 being used for a higher data throughput relative to the second BWP 420. The second BWP 420 may be configured with a smaller bandwidth relative to the first BWP 412 based at least in part on reducing a transmission size and/or processing associated with the transmission to reduce power consumption at a UE. Thus, a network node may configure and/or select a BWP based at least in part on a variety of factors, such as UE power requirements, data throughput, and/or spectrum usage. For instance, the network node may configure and/or select a BWP associated with a frequency bandwidth of 5 MHz based at least in part on using the BWP for communications with a RedCap UE and/or an IoT with limited capabilities as further described above.

In some aspects, only a single BWP of the multiple BWPs may be active per transmission direction at a given time, such as a single active BWP for uplink (UL) transmissions and/or a single active BWP for DL transmissions. Alternatively or additionally, the single active BWP may be associated with bi-directional transmissions, such as TDD transmissions that share a same frequency for UL and DL transmissions based at least in part on time partitioning. Accordingly, a network node (e.g., the network node 110) may direct a UE (e.g., the UE 120) to switch from using a first BWP as an active BWP to using a second BWP as the active BWP. To illustrate, the UE may utilize an initial BWP when operating in a radio resource control idle (RRC_IDLE) mode and switch to a different BWP when operating in a radio resource control connected (RRC_CONNECTED) mode. That is, the UE may communicate with the network node by initially using the initial BWP as the active BWP and then switch to using the different BWP as the active BWP.

As described above, a BWP may be designated part from an overall carrier bandwidth and/or is a subset of a total available channel bandwidth for a given carrier. The use of BWPs enables a network node to configure communications with a UE in a manner that increases an overall capacity and/or overall performance of a wireless network (e.g., increased data throughput and/or decreased data transfer latencies within a given time span). At times, a network node may reconfigure a BWP that is used by a UE, such as by reconfiguring the BWP to adapt to current network conditions, to meet a QoS requirement, to adapt to communication channel changes (e.g., based at least in part on UE mobility), and/or to adapt to spectrum availability. A BWP switch may be governed by one or more operating criteria, such as a delay operating criterion and/or a timing operating criterion that the network node and/or the UE may be obligated to fulfill in order to operate in a wireless network. For instance, a communication standard may specify the delay operating criterion and/or the timing operating criterion, and the network node and/or the UE may be obligated to meet the delay operating criterion and/or the timing criterion to be compliant with the communication standard and/or to operate in a wireless network that is based at least in part on the communication standard.

To illustrate, the communication standard may specify a switching delay criterion that governs a BWP switching process, and a network node and/or UE involved in the BWP switching process may be obligated to meet and/or fulfill the switching delay. For instance, the UE may be obligated to finalize and/or complete BWP switching within the switching delay. As one example, the UE may experience a transmission/reception delay that is associated with a latency between the network node transmitting a communication that indicates a BWP switch instruction (e.g., in DCI), and the UE receiving the communication. Alternatively, or additionally, the UE may incur a processing delay between receiving and decoding the BWP switching instruction. That is, the UE may experience a time delay between receiving a transmission that indicates a BWP switching instruction and decoding the BWP switching instruction from the transmission. To operate in a wireless network, the UE may be obligated to complete and/or finalize a BWP switch, including a transmission/reception delay and a processing delay in combination with a hardware change and/or hardware settling, within the switching delay criterion.

In some scenarios, a carrier may be partitioned into multiple BWPs, and a first BWP in the carrier may be linked to a second BWP in the carrier. To illustrate, a network node may configure a UE with a set of downlink BWP configurations and a set of uplink BWP configurations within the carrier by indicating the set of downlink BWP configurations and/or a set of uplink BWP configurations in RRC signaling. Each downlink BWP configuration may be associated with a respective index and/or a BWP ID, and the respective index and/or BWP ID may be linked to a respective uplink BWP configuration. That is, a first BWP in the carrier and a second BWP in the carrier may be linked through an association with a same index and/or BWP ID. At a later point in time, the network node may indicate to switch BWPs and/or BWP configurations by indicating an index and/or BWP ID to the UE (e.g., via DCI), which may be referred to as DCI-based BWP switching. Alternatively, or additionally, the network node may configure the UE (e.g., in RRC signaling) to perform timer-based BWP switching that includes the network node configuring a timer value in combination with an index and/or BWP ID for a BWP switch. Based at least in part on expiration of the timer, the UE may perform BWP switching to the BWP indicated by the BWP ID and/or index.

In some cases the UE may interpret a BWP switch instruction as an instruction to configure all of the linked BWPs. For instance, the UE may receive a BWP switch instruction that indicates to switch a downlink BWP configuration, and the instruction may indicate an index and/or BWP ID of the BWP configuration to use. The UE may interpret the BWP switch instruction as an instruction to switch both a downlink BWP configuration and an uplink BWP configuration based at least in part on the index and/or BWP ID being linked to multiple BWP configurations. The linkage between BWP configurations (e.g., a downlink BWP configuration and an uplink BWP configuration) may be governed by a communication standard. As one example, for unpaired spectrum operation (e.g., an operating environment in which uplink transmissions and downlink transmissions occur in separate, non-overlapping frequency ranges), the communication standard may disallow a configuration in which a center frequency for a downlink BWP configuration is different than a center frequency for an uplink BWP configuration for linked BWP configurations. That is, the communication standard may specify that linked BWP configurations in a same carrier use a same center frequency.

Alternatively, or additionally, the communication standard may specify a blanking duration that is associated with BWP switching (e.g., a DCI-based BWP switching and/or a timer-based BWP switching). “Blanking” may denote a UE ceasing to transmit a signal and/or ceasing to receive a signal via a communication chain, and a blanking duration may be a time span in which the UE performs blanking. For instance, the communication standard may specify to perform blanking on an uplink communication channel and/or blanking on a downlink communication channel for a blanking duration. In some cases, the communication standard may specify different blanking durations for different UE device types and/or based at least in part on a UE capability. A blanking duration may differ from a switching delay, and the UE may perform blanking within the switching delay. The use of blanking may mitigate interference in the BWP that the UE is switching away from.

“Joint BWP switching” may denote a UE reconfiguring each communication chain of multiple communication chain with a respective BWP configuration together and/or during a same switching duration based at least in part on a linkage between the BWP configurations. To illustrate the UE may reconfigure a first communication chain (e.g., a downlink communication chain and/or a receiver communication chain) using a first BWP configuration and may reconfigure a second communication chain (e.g., an uplink communication chain and/or a transmitter communication chain) using a second BWP configuration that is linked to the first BWP configuration. In some cases, joint BWP switching may result in performance degradation in a wireless system, such as increased data transfer latencies, reduced data throughput, and/or sub-optimal air interface resource usage. For instance, the network node may instruct the UE to perform a BWP switch using a first BWP configuration that the network node selected to be optimized for downlink communications, and the first BWP configuration may be linked to a second BWP configuration that is sub-optimal for uplink communications. As one example, a downlink data traffic pattern may differ from an uplink data traffic pattern, and the network node may select a downlink BWP configuration based at least in part on the downlink data traffic pattern. However, the linked uplink BWP configuration may be sub-optimal for the uplink data pattern and, tased at least in part on performing joint BWP switching, the UE may reconfigure a transmitter communication chain and/or an uplink communication chain using the (linked) sub-optimal BWP configuration. The sup-optimal BWP configuration may result sub-optimal bandwidth usage and/or sub-optimal air interface resource usage by the UE and, consequently, air interface resource waste. As another example, the network node may trigger a BWP switch based at least in part on downlink communications, and the joint BWP switching may unnecessarily introduce a latency in uplink communications that introduces a delay in time-sensitive applications and may result in a failure to meet a time-based operating condition and/or a QoS operating condition.

Various aspects relate generally to configuring a first communication chain for a BWP change without modifying a second communication chain. Some aspects more specifically relate to a UE configuring the first communication chain to use an updated BWP, and maintaining, in parallel, communications on the second communication chain (e.g., not performing blanking on the second communication chain). In some aspects, a UE may transmit UE capability information that indicates support for independently modifying a BWP configuration of a first communication chain that is configured with a first BWP in a carrier without modifying a second communication chain that is configured with a second BWP in the carrier. In some aspects, the first communication chain may be a receiver communication chain (e.g., for processing a downlink signal and/or a first sidelink signal) and the second communication chain may be a transmitter communication (e.g., for processing an uplink signal and/or a second sidelink signal), or vice versa. Based at least in part on indicating support for independently modifying the BWP configuration of the first communication chain without modifying the second communication chain, the UE may receive an instruction to reconfigure the first communication chain to a third BWP in the carrier without modifying the second communication chain. That is, the instruction may indicate to only reconfigure the first communication chain. In some aspects, the UE may use the second communication chain while reconfiguring the first communication chain, resulting in reduced data transfer latencies relative to joint BWP switching.

In some aspects, a network node may receive UE capability information that indicates support for independently modifying a BWP configuration of a first communication chain that is configured with a first BWP in a carrier without modifying a second communication chain that is configured with a second BWP in the carrier. Based at least in part on receiving the indication of the support for independently modifying the BWP configuration of the first communication chain without modifying the second communication chain, the network node may transmit an instruction to reconfigure the first communication chain with a third BWP in the carrier without modifying the second communication chain. That is, the instruction may indicate to only modify the first communication chain and/or may not indicate to modify the second communication chain. In some aspects, the network node may transmit the instruction based at least in part on a scheduling pattern. To illustrate, the network node may leverage an uplink time partition by instructing the UE to reconfigure a downlink communication chain during at least part of the uplink time partition.

Particular aspects of the subject matter described in this disclosure can be implemented to realize one or more of the following potential advantages. In some examples, by using independent BWP switching for multiple communication chains (e.g., instead of using joint BWP switching), the described techniques can be used to enable a network node to leverage a scheduling pattern and instruct a UE to reconfigure a first communication chain during a time partition that is associated with a second communication chain. For example, the network node may instruct a UE to reconfigure a BWP of a downlink communication chain during an uplink time partition (e.g., a time partition in which the downlink communication chain will be unused) to reduce data transfer latencies and/or increase data throughput of the downlink chain (or vice versa). The use of independent BWP switching may also enable the network node to select unlinked BWP configurations for each communication chain used by a UE and/or select respective BWP configurations that are optimized for the communication chain. For instance, the network node may select a first downlink BWP configuration that reduces air interface resource waste based at least in part on a downlink data traffic pattern and/or may select a second BWP configuration (e.g., that is not linked to the first BWP configuration) that reuses air interface resource waste based at least in part on an uplink data traffic pattern. Alternatively, or additionally, the network node may select each BWP configuration to reduce a respective data transfer latency and/or satisfy a QoS operating condition. Mitigating air interface resources waste may reduce data transfer latencies and/or increase data throughput.

As indicated above, FIG. 4 is provided as an example. Other examples may differ from what is described with regard to FIG. 4.

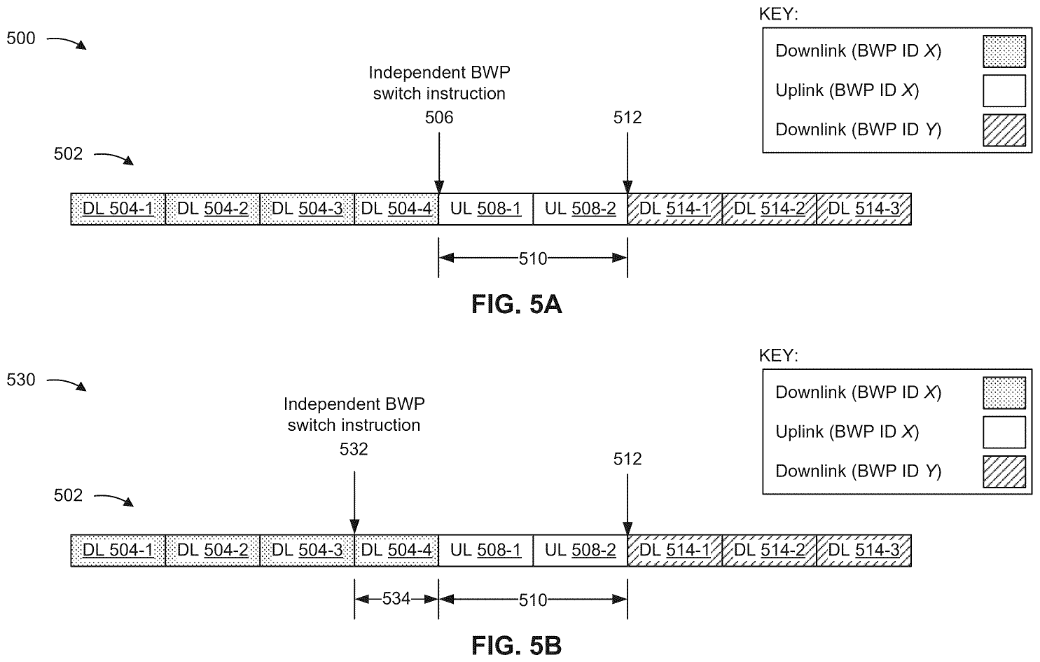

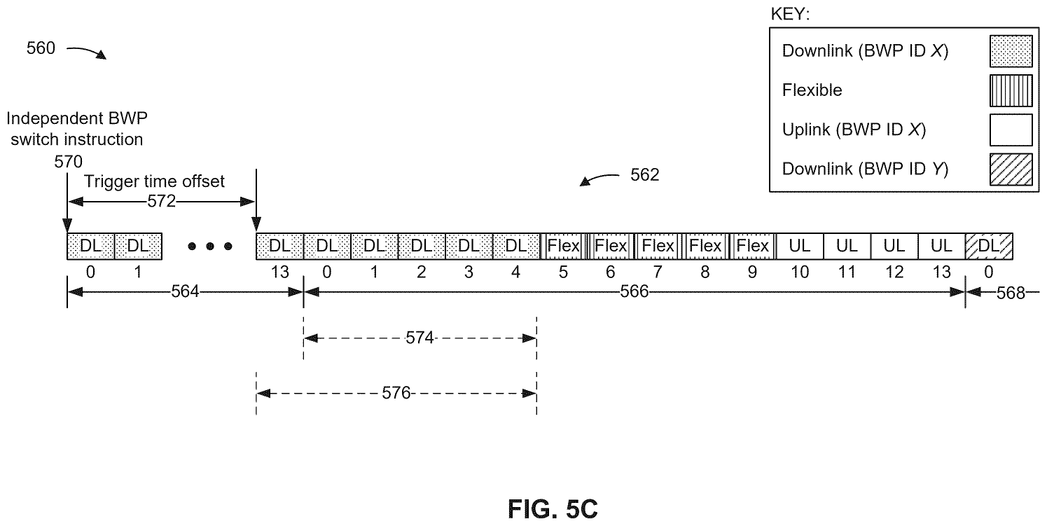

FIGS. 5A, 5B, and 5C are diagrams illustrating a first example 500, a second example 530, and a third example 560, respectively, of independent BWP switching, in accordance with the present disclosure.

A network node (e.g., a network node 110) may configure a UE (e.g., a UE 120) to perform independent and/or separate BWP switching of communication chains, such as communication chains that that may be configured with BWPs in a same carrier. “Independent BWP switching” may denote reconfiguring a first BWP of a first communication chain without reconfiguring a second BWP of a second communication chain. In some aspects, a UE may perform independent BWP switching in scenarios that include the first BWP and the second BWP being in a same carrier and/or communication chains that are associated with different subscriptions. In some aspects, the network node may instruct the UE to perform independent BWP switching based at least in part on a scheduling pattern and/or a grant pattern. For example, the network node may leverage a transition from a first time partition that is associated with a first communication to a second time partition that is associated with a second communication direction that is different from the first communication direction (e.g., downlink and uplink, respectively, uplink and downlink, respectively, and/or different sidelink directions), to trigger an independent BWP switch at a UE that mitigates data transfer latencies and/or increases data throughput in a wireless network. By staggering independent BWP switching based at least in part on a scheduling pattern, a network node may instruct a UE to reconfigure a first communication chain during a time partition in which the UE will not be using the first communication chain and/or may use a second communication.

To illustrate, in a TDD system, the network node may instruct the UE to reconfigure a downlink communication chain during an uplink time partition, or an uplink communication chain during a downlink time partition (or vice versa). Alternatively, or additionally, the UE may use the uplink communication chain in parallel with reconfiguring the downlink communication chain (or vice versa). As another example, the network node may instruct the UE to reconfigure a transmitter communication chain (e.g., used to transmit a sidelink transmission and/or an uplink transmission) separately from reconfiguring a receiver communication chain (e.g., used to receive a sidelink transmission and/or a downlink transmission). Independent BWP switching may also be referred to as Type 3 BWP switching and may at times include the UE reconfiguring a first communication chain without blanking the second communication chain during the reconfiguration of the first communication chain. In some aspects, the UE may perform blanking on the communication chain being reconfigured.

The first example 500 shown by FIG. 5A includes a scheduling pattern 502 for a UE (e.g., a UE 120) that may be based at least in part on TDD. As such, the scheduling pattern 502 may include multiple time partitions (e.g., a slot, a mini-slot, and/or a symbol), and each time partition may be assigned to either downlink communications (shown as DL) or uplink communications (shown as UL). While the scheduling pattern 502 is shown by FIG. 5A as including multiple time partitions in the form of a slot, a scheduling pattern may alternatively or additionally include multiple frequency partitions that are based at least in part on FDD.

In the example 500, the UE may be configured to use a downlink BWP that is assigned a BWP ID of X (e.g., downlink BWP X) and an uplink BWP that is also assigned the BWP ID of X (e.g., uplink BWP X). In some aspects, the downlink BWP X and the uplink BWP X may be linked via the same BWP ID. Accordingly, and based at least in part on the scheduling pattern 502, the UE may receive one or more downlink signals in the downlink partition 504-1, the downlink partition 504-2, the downlink partition 504-3, and the downlink partition 504-4 using a downlink communication chain that is configured to receive signals in the downlink BWP X (shown with a dotted pattern).

A network node may leverage the scheduling pattern 502 to trigger independent BWP switching at the UE. To illustrate, the UE may indicate, to the network node, support for independent BWP switching, such as by indicating support for Type 3 BWP switching in UE capability information. Based at least in part on the UE indicating support for independent BWP switching, the network node may coordinate a downlink independent BWP switch to align with an uplink time partition in the scheduling pattern 502 and/or may use the uplink time partition as an interruption window to perform the downlink independent BWP switch to mitigate an interruption in the downlink communication chain during a downlink time partition. Other examples may include coordinating an uplink independent BWP switch with a downlink time partition, a receiver chain independent BWP switch with a time partition associated with transmitting, and/or a transmitter chain independent BWP switch with a time partition associated with receiving.

As one example, the network node may determine to trigger a BWP switch from the downlink BWP X to a downlink BWP that is assigned a BWP ID of Y (e.g., downlink BWP Y) for the downlink communication chain. Based at least in part on the scheduling pattern 502, the network node may transmit an independent BWP switch instruction 506 at a start, or near a start of an uplink partition 508-1, such as by transmitting the independent BWP switch instruction 506 in DCI that includes control information for an uplink transmission that uses the uplink partition 508-1. That is, the network node may schedule the UE to perform a downlink independent BWP switch during one or more the uplink time partitions in the scheduling pattern 502 (e.g., the uplink time partition 508-1 an uplink time partition 508-2) to mitigate downlink data transfer latency at the UE and/or effectively utilize the UE resources to increase downlink data throughput (e.g., by scheduling an independent downlink BWP switch during an uplink time partition instead of during a downlink time partition).

For instance, with regard to the first example 500, the network node may transmit the independent BWP switch instruction 506 based at least in part on the downlink partition 504-4 being at a transition boundary to the uplink partition 508-1. Based at least in part on including an independent BWP switching capability, the UE may transmit one or more uplink signals in the uplink partition 508-1 and the uplink partition 508-2 using an uplink communication chain that is configured for transmitting in the uplink BWP X (shown in solid white). Alternatively, or additionally, the UE may reconfigure the downlink communication chain from receiving signals in the BWP X to receiving signals in the BWP Y during at least part of time span 510 (e.g., during at least part of the uplink partition 508-1 and/or the uplink partition 508-2). That is, the UE may reconfigure the downlink communication chain from using a BWP that is linked to the uplink BWP X to using a BWP that is not linked to the uplink BWP X (e.g., BWP Y). As shown by reference number 512, the UE may complete the reconfiguration of the downlink communication chain no later than the end of the uplink partition 508-2 such that the UE may receive one or more downlink signals in downlink partition 514-1, downlink partition 514-2, and/or downlink partition 514-3 via the reconfigured downlink communication chain in the BWP Y (shown with a diagonal striped pattern).

While the first example 500 is an example of a network node staggering separate and independent BWP switching based at least in part on TDD time partitions, the network node may use alternate or additional information to coordinate independent BWP switching in a manner that reduces latencies. As one example, the network node may coordinate and/or trigger the UE to reconfigure an uplink communication chain during a time period and/or duration where the UE is not expected to do any form of uplink transmissions (e.g., a PUCCH transmission, a PUSCH transmission, and/or a SRS transmission) and/or during a duration that includes continuous downlink transmissions.

Alternatively, or additionally, the network node may be unable to leverage a scheduling pattern for an independent BWP switch instruction. For example, the network node may transmit a downlink independent BWP switch instruction at a time in which a scheduling pattern includes multiple adjacent downlink time partitions. To illustrate, the network node may transmit, and the UE may receive, a downlink independent BWP switch instruction in DCI that includes control information for a downlink transmission that uses the downlink time partition 504-1. In such a scenario, the UE may reconfigure the downlink communication chain BWP separately and/or independently from configuring an uplink communication chain, and the UE May perform blanking on the downlink communication chain for a blanking duration as specified by a communication standard.

The second example 530 shown by FIG. 5B includes the scheduling pattern 502 described with regard to FIG. 5A. In some aspects, a UE may initiate an independent BWP switching process and/or reconfigure a communication chain after a trigger time offset. To illustrate, the UE may activate a timer (with a trigger time offset) at a point in time that the UE receives the independent BWP switch instruction, such as the point in time that the UE receives PDCCH that includes DCI that indicates the independent BWP switch instruction and/or the UE decodes the DCI. Based at least in part on expiration of the timer, the UE may initiate and/or trigger reconfiguring the communication chain to use a new BWP indicated in the independent BWP switch instruction. The use of a trigger time offset may enable the UE to avoid and/or mitigate an interruption in a current BWP of the communication chain being reconfigured. In some aspects, the UE may use the trigger time offset to delay reconfiguring a communication chain based at least in part on a first amount of time that the UE uses to perform the BWP switching (e.g., reconfiguring a communication chain) is less than a second amount of time available for the UE to communicate (e.g., transmit and/or receive communications) via the reconfigured communication chain using the new BWP. In some aspects, the UE may indicate the trigger time offset in UE capability information that is transmitted to the network node.

To illustrate, a network node may transmit an independent BWP switch instruction 532 at a start, or near a start, of the downlink time partition 504-4, such as by transmitting the independent BWP switch instruction 532 in the DCI that indicates one or more configuration parameters of a downlink transmission that uses the downlink time partition 504-4. As shown by FIG. 5B, the downlink time partition 504-4 is the last downlink time partition prior to an uplink time partition (e.g., the uplink time partition 508-1). The network node may transmit the independent BWP switch instruction 532 based at least in part on a trigger time offset UE capability of the receiving UE to leverage using at least part of the uplink time partition 508-1 as an interruption window for reconfiguring the downlink communication chain and/or during a time span the downlink communication chain will not be used. For example, the network node may advance transmission of the independent BWP switch instruction 532 in time (e.g., advance before the uplink partition 508-1) based at least in part on the trigger time offset used by the UE.

As shown by reference number 534, based at least in part on a trigger time offset, the UE may delay reconfiguring the downlink communication chain until at least the start of the uplink time partition 508-1. For instance, the UE may activate a timer that is configured with the trigger time offset based at least in part on receiving the independent BWP switch instruction 532, and may initiate reconfiguring the downlink communication chain based at least in part on expiration of the timer. As an example, the trigger offset delay at the UE may be one slot (e.g., 1 msec for a 15 kHz sub-carrier spacing), and the network node may transmit the independent BWP switch instruction 532 at a point in time that is at least 1 msec advanced from a desired interruption window. For instance, in the example 530, the network node transmits the independent BWP switch instruction 532 in DCI that indicates configuration information for a downlink transmission that uses the downlink partition 504-4 (e.g., 1 slot and/or 1 msec advanced from the desired interruption window of the uplink time partition 508-1). The UE may trigger the BWP switching after the trigger offset delay (e.g., based at least in part on expiration of the timer), resulting in the UE reconfiguring the downlink communication chain during the uplink time partition 508-1 and leveraging the uplink time partition as an interruption window for the downlink communication chain.

In the example 530, the independent BWP switch instruction 532 may indicate to change a BWP configuration of a downlink communication chain, but in other examples, the independent BWP switch instruction 532 may indicate to change a BWP configuration of an uplink communication chain, a receiver communication chain, and/or a transmitter communication chain. For example, the network node may indicate to coordinate uplink independent BWP switching during continuous downlink activity, such as by transmitting an independent BWP switching instruction in uplink control information that is indicated in DCI, resulting in the UE using a downlink time partition as an interruption window for reconfiguring an uplink communication chain.

The third example 560 shown by FIG. 5C is an example of a network node adjusting a scheduling pattern based at least in part on independent BWP switching. The third example 560 includes a scheduling pattern 562 that is shown by FIG. 5C with a symbol time partition granularity in combination with a slot time partition granularity. A first slot 564 includes 14 downlink symbols that are allocated to downlink communications (shown as DL 0, DL 1, up to DL 13). A second slot 566 includes a combination of downlink symbols (shown as DL 0, DL 1, DL 2, DL 2, and DL 4), flexible symbols that may be allocated to either downlink communications or uplink communications (shown as Flex 5, Flex 6, Flex 7, Flex 8, and Flex 9), and uplink symbols that are allocated to uplink communications (shown as UL 10, UL 11, UL 12, and UL 13). A third slot 568 is partially shown as including a downlink symbol that is allocated to downlink communications (shown as DL 0). A UE associated with the scheduling pattern 562 may initially be configured to use the scheduling pattern 562 based at least in part on configuring a downlink communication chain for a BWP ID X (shown in the first slot 564 and the second slot 566 in the downlink symbols through the use of a dotted pattern) and an uplink communication chain for a BWP ID X (shown in the second slot 566 in the uplink symbols through the use of solid white). Flexible symbols in the second slot 566 are shown through the use of vertical stripes. While the scheduling pattern 562 includes flexible symbols, other scheduling patterns may not include flexible symbols.

In some aspects, a UE may indicate (e.g., in UE capability information) BWP switching information, such as an amount of time used by the UE to perform independent BWP switching. The BWP switching information may indicate one or more of a general BWP switching time that is a first amount of time used by the UE to reconfigure any type of communication chain (e.g., an uplink communication chain, a downlink communication chain, a transmitter communication chain, and/or a receiver communication chain), a receiver BWP switching time that is a second amount of time used by the UE to reconfigure a receiver communication chain, and/or a transmitter BWP switching time that is a third amount of time used by the UE to reconfigure a transmitter communication chain. Accordingly, the UE may indicate general independent BWP switching times, receiver-specific independent BWP switching times, and/or transmitter-specific independent BWP switching times. Alternatively, or additionally, the UE may indicate (e.g., in UE capability information) a trigger time offset in a similar manner as described with regard to the second example 530.

In some aspects, a network node may adjust a scheduling pattern, such as by adjusting and/or reassigning a time partition a communication direction in the scheduling pattern 562 to mitigate data transfer latencies and/or to increase data throughput at the UE. To illustrate, the UE may indicate a general independent BWP switching time of nine (9) symbols. The network node may transmit a downlink independent BWP switch instruction 570 in DCI that configures the first slot 564, and the UE may activate a timer that is set to expire after a trigger time offset 572. In some aspects, the network node may indicate to use the flexible symbols as uplink symbols and/or to use the flexible symbols for performing an independent BWP switch

To illustrate, in the third example 560, a UE may indicate a duration for the trigger time offset 572, and the duration for the trigger time offset 572 may be longer that a duration of a time offset 574 from the start of the second slot 566 to the first flexible symbol (e.g., Flex 5). Accordingly, the network node may transmit the independent BWP switch instruction 570 in DCI that configures the first slot 564 to compensate for the trigger time offset 572, and may instruct the UE to add an additional delay (e.g., time offset 574 from the start of the second slot 566 or time offset 576 from the start of expiration of the trigger time offset) to when the UE initiates the independent BWP switch. As shown by FIG. 5C, the addition delay may result in the UE performing the independent BWP switch in the flexible slots that span symbols 5-9, which mitigates interruptions in downlink communications, reduces downlink data transfer latencies, and/or increases downlink data throughput.

The reconfiguration of the first downlink symbol in the third slot 568 is further shown in FIG. 5C through the use of diagonal stripes that are associated with the downlink communication chain being reconfigured to the BWP ID Y. Other examples may include the UE performing uplink independent BWP switching during any combination of flexible symbols and/or downlink symbols.

The use of independent BWP switching may enable a network node to leverage a scheduling pattern and instruct a UE to reconfigure a first communication chain during a time partition that is associated with a second communication chain. For example, the network node may instruct a UE to reconfigure a BWP of a downlink communication chain during an uplink time partition (e.g., a time partition in which the downlink communication chain will be unused) to reduce data transfer latencies and/or increase data throughput of the downlink chain (or vice versa). The use of independent BWP switching may also enable the network node to select unlinked BWP configurations for each communication chain used by a UE and/or select respective BWP configurations that are optimized for the communication chain. For instance, the network node may select a first downlink BWP configuration that reduces air interface resource waste based at least in part on a downlink data traffic pattern and/or may select a second BWP configuration (e.g., that is not linked to the first BWP configuration) that reuses air interface resource waste based at least in part on an uplink data traffic pattern. Alternatively, or additionally, the network node may select each BWP configuration to reduce a respective data transfer latency and/or satisfy a QoS operating condition. Mitigating air interface resources waste may reduce data transfer latencies and/or increase data throughput.

As indicated above, FIGS. 5A, 5B, and 5C are provided as examples. Other examples may differ from what is described with regard to FIGS. 5A, 5B, and 5C.

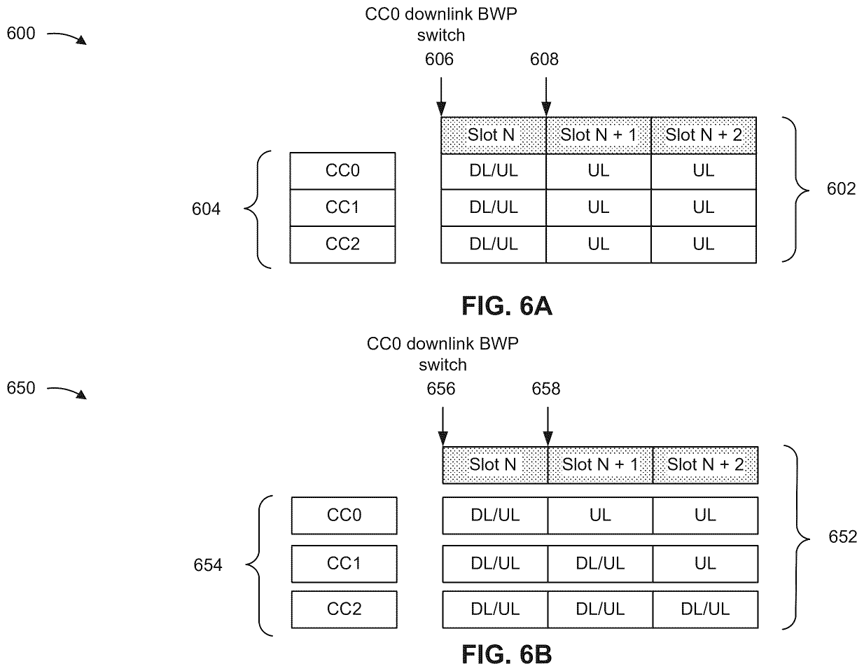

FIGS. 6A and 6B are diagrams illustrating a first example 600 and a second example 650 of independent BWP switching based at least in part on carrier aggregation, in accordance with the present disclosure.

In some aspects, a UE may support independent BWP switching that is based at least in part on carrier aggregation (CA). To illustrate, CA may use multiple carriers (e.g., component carriers (CCs)) that may be spread across different frequency bands or a same frequency band, and a UE may use different communication chains to transmit and/or receive the multiple carriers and/or the UE may process each carrier using a respective communication chain. Based at least in part on an architecture of how the UE implements CA, a BWP switch for a first carrier may impact a second carrier. To illustrate, a network node may provide multiple different component carriers using different cells (e.g., each cell is associated with a respective component carrier), and the network node may configure a UE with CA using different component carriers in different cells. In some aspects, a BWP switch to a first component carrier that is associated with a first cell (e.g., an first uplink component carrier and/or a first downlink component carrier) may interrupt and/or impact communications associated with a second component carrier that is associated with a second cell (e.g., a second uplink component carrier and/or a second downlink component carrier).

In some aspects a UE may indicate (e.g., in UE capability information) one or more cell and/or component carrier combinations that may be linked at the UE based at least in part on BWP switching. That is, the UE may indicate a first component carrier and/or first cell that may interrupt and/or impact communications that use a second component carrier and/or second cell based at least in part on a BWP switch associated with the first component carrier. The UE may indicate the cell and/or component carrier combinations in a variety of manners, such as by indicating a frequency band combination (e.g., a first frequency band and a second frequency band) that may potentially interrupt communications for one another during an independent BWP switch, a cell combination (e.g., a first cell and a second cell) that may potentially interrupt communications for one another during the independent BWP switch, and/or a component carrier trigger time offset associated with the independent BWP switch.

In some aspects, the component carrier trigger time offset indicated by the UE is scalable and/or may be used to compute a component carrier trigger time offset for multiple component carriers. For example, the component carrier trigger time offset may be a function of a number of component carriers that the UE is reconfiguring (e.g., a number of component carriers that are undergoing a respective BWP switching). In some aspects, the UE may indicate, as the component carrier trigger time offset, a single trigger time offset that is associated with performing BWP switching for a single component carrier, and the component carrier trigger time offset used by the UE to trigger independent BWP switching process may be dependent on the number of additional component carriers that the UE is reconfiguring simultaneously (e.g., a number of component carriers that are simultaneously undergoing BWP switching). Alternatively, or additionally, the UE may indicate a base component carrier trigger time offset and a relative component trigger time offset that is scalable based at least in part on a number of component carriers. To illustrate, for three component carriers, a component carrier trigger time offset may be computed using the base component carrier trigger time offset in combination with the relative component trigger time offset as follows:

$$total component carrier trigger time offset = base component carrier trigger time offset + ( ( total number of component carriers - 1 ) \times relative component carrier trigger offset )$$

$$total component carrier trigger time offset = base component carrier trigger time offset + ( 2 \times relative component carrier trigger offset )$$

The UE may indicate, as at least part of indicating the cell combination associated with independent BWP switching, a communication direction associated with the cell (e.g., uplink, downlink, transmission, and/or reception). For instance, the UE may indicate, as the cell combination, a first cell and a first communication direction of the first cell that is linked to a second cell and a second communication direction of the second cell. (e.g., an independent BWP switch in the first cell that is associated with the first communication direction may interrupt communications in the second direction of the second cell). In indicating a communication direction, the UE may indicate multiple communication directions (e.g., uplink and downlink and/or transmission and reception). That is, the UE may indicate which component carrier combinations and/or cell combinations may impact one another during independent BWP switching, and the UE may indicate that the communication directions impacted may include uplink only, downlink only, transmission only, reception only, uplink and downlink, and/or transmission and reception. Accordingly, the UE may indicate (e.g., in UE capability information) component carrier combinations and/or cell combinations that impact one another (or do not impact one another) during independent BWP switching and/or the UE may indicate communication directions of the component carrier combinations and/or cell combinations that impact one another (or do not impact one another) during independent BWP switching. In some aspects, the UE may indicate multiple component carriers and/or cells (e.g., more than two) in the component carrier combinations and/or cell combinations. Alternatively, or additionally, the UE may one or more frequency bands within each component carrier and/or cell that may cause interruption in other frequency bands a linked component carrier and/or a linked cell during independent BWP switching.

Based at least in part on the component carrier combination and/or cell combination information, a network node (e.g., a network node 110) may leverage CA scheduling information to schedule an independent BWP switch that mitigates data transfer latencies and/or increases data throughput at a UE (e.g., a UE 120). To illustrate, the first example 600 shown by FIG. 6A includes a CA scheduling pattern 602 for three component carriers 604, shown as CC0, CC1, and CC2. In the first example 600, the three component carriers 604 are contiguous component carriers (e.g., adjacent to one another in a frequency domain), and the CA scheduling pattern 602 is for contiguous CA. As shown by FIG. 6A, the CA scheduling pattern 602 includes scheduling information for time-adjacent time partitions, shown as slot N, slot N+1, and slot N+2, but other CA scheduling patterns may be based at least in part on other time partitions (e.g., a mini-slot, a symbol, a sub-frame, and/or a frame). In slot N, each component carrier is scheduled with a flexible slot that may be downlink or uplink, shown as DL/UL. In slot N+1 and slot N+2, each component carrier is scheduled and/or assigned an uplink slot, shown as UL.

In a first UE architecture, a UE that is assigned the CA scheduling pattern 602 may use a first phase-locked loop (PLL) for receiving downlink communications in the three component carriers 604, and different PLLs for receiving uplink communications in the three component carriers 604. Based at least in part on the first UE architecture, a change in a downlink BWP may interrupt an entirety of downlink communications that use the three component carriers 604 (but not uplink communications) and/or a change in an uplink BWP may interrupt an entirety of the uplink communications that use the three component carriers 604 (but not downlink communications). Accordingly, the UE may indicate a downlink component carrier combination and/or a downlink cell combination that indicates a BWP change in the first component carrier, the second component carrier, and/or the third component carriers may affect one another. Other examples of parameters and/or configurations that may result in interruptions may include a UE architecture that includes any combination of a low intermediate frequency (LIF) canceler, a spur notch, and/or automatic gain control (AGC) switch points that use different linearity modes.

As shown by reference number 606, a network node may transmit an independent BWP switch instruction for the first component carrier (e.g., CC0) in DCI that configures a first component carrier communication that uses slot N. Based at least in part on a trigger time offset, the UE may delay performing independent BWP switching for the first component carrier (e.g., delay reconfiguring the associated communication chain) until a start of the slot N+1 as shown by reference number 608. The UE may use at least a part of the slot N+1 and/or the slot N+2 to reconfigure the downlink communication chain, and the use of uplink slots to reconfigure the downlink communication chain may mitigate interruptions in downlink communications for the three component carriers 604 (e.g., by performing the reconfiguring in an uplink slot), resulting in reduced data transfer latencies and/or increased data throughput in downlink communications. Alternatively, or additionally, performing independent BWP switching for the downlink communication chain may mitigate interruptions to uplink communications that use the uplink slots, resulting in increased data throughput and/or reduced data transfer latencies in uplink communications. Accordingly, the network node may trigger the downlink independent BWP switch at a point in time that mitigates interruptions in the downlink component carriers (e.g., during slot N+1 and slot N+2 that are allocated to uplink communications for all of the component carriers).

In a second UE architecture, a UE that is assigned the CA scheduling pattern 602 may use a single PLL for processing all downlink communications that are associated with the three component carriers 604 that are contiguous with one another, and may use the same PLL for processing all uplink communications that are associated with the three component carriers 604. Based at least in part on the second UE architecture, a BWP change to any component carrier (e.g., uplink or downlink) may affect and/or interrupt all communications. For instance, as shown by reference number 606, the network node may transmit an independent BWP switch instruction for the first component carrier (e.g., CC0), and, as shown by reference number 608, the UE may delay performing the independent BWP switching for the first component carrier until a start of the slot N+1 as shown by reference number 608. Based at least in part on using a single PLL for uplink communications and downlink communications for the three component carriers 604, the UE reconfiguring the downlink BWP of the first component carrier (e.g., via independent BWP switching) may result in communication interruptions to the uplink communications that use slot N+1 and slot N+2. However, the use of the uplink slots (e.g., slot N+1 and slot N+2) for reconfiguring the downlink BWP of the first component carrier may help mitigate interruptions to downlink communications, resulting in reduced downlink data transfer latencies and increased downlink data throughput. Accordingly, the UE may indicate that a component carrier combination and/or a cell combination that indicates a BWP change in the first component carrier, the second component carrier, and/or the third component carriers may affect one another for both uplink and downlink.

In a third UE architecture, a UE that is assigned the CA scheduling pattern 602 may use a first PLL for processing all downlink communications that use the three component carriers 604 that are contiguous with one another, and a second PLL (e.g., different from the first PLL) for processing all uplink communications that use the three component carriers 604. In some aspect, based at least in part on performing downlink independent BWP switching for the first component carrier (e.g., CC0), the UE may reconfigure a PLL used to processing downlink communications that use the first component carrier. For instance, the UE may cease using the first PLL and/or may begin using a third PLL for processing downlink communications that use the first component carrier. However, the UE may continue to use the first PLL to process downlink communications that use the second component carrier (e.g., CC1) and the third component carrier (e.g., CC2). Accordingly, and as described above, the UE may indicate combinations of CCs (e.g., in UE capability information) that may be associated with one another with regards to independent BWP switching that the network node may leverage to mitigate interruptions to uplink and/or downlink communications.

As shown by reference number 606, the network node may transmit an independent BWP switch instruction for the first component carrier, and, as shown by reference number 608, the UE may delay performing the independent BWP switching for the first component carrier (e.g., CC0) until a start of the slot N+1 as shown by reference number 608. Based at least in part on using a third PLL to process downlink communications for the first component carrier, and using the first PLL and the second PLL for the other communications, the UE may reconfigure the BWP that is used for the first component carrier without interruption to the uplink communications that use the slot N+1 and the slot N+2.

The second example 650 shown by FIG. 6B includes a CA scheduling pattern 652 for three component carriers 654, shown as CC0, CC1, and CC2, that are inter-band, non-contiguous component carriers (e.g., are not adjacent to one another in a frequency domain). As shown by FIG. 6B, the CA scheduling pattern 652 includes scheduling information for time-adjacent time partitions, shown as slot N, slot N+1, and slot N+2, but other CA scheduling patterns may be based at least in part on other time partitions (e.g., a mini-slot, a symbol, a sub-frame, and/or a frame). In slot N, each component carrier is scheduled with a flexible slot that may be downlink or uplink, shown as DL/UL. Slot N+1 and slot N+2 of the first component carrier (e.g., CC0) are configured as uplink slots, slot N+1 and slot N+2 of the second component carrier (e.g., CC1) are configured as a flexible slot and an uplink slot, respectively, and slot N+1 and slot N+2 of the third component carrier (e.g., CC1) are configured as flexible slots.

In a fourth UE architecture, a UE that is assigned the CA scheduling pattern 652 may include the UE using a different PLL for each component carrier and communication direction. To illustrate, the UE may use a first PLL for downlink communications that use the first component carrier (e.g., CC0), a second PLL for uplink communications that use the first component carrier, a third PLL for downlink communications that use the second component carrier (e.g., CC1), a fourth PLL for uplink communications that use the second component carrier, a fifth PLL for downlink communications that use the third component carrier (e.g., CC2), and a sixth PLL for uplink communications that use the third component carrier. Accordingly, and as described above, the UE may indicate combinations of CCs (e.g., in UE capability information) that may be associated with one another with regards to independent BWP switching that the network node may leverage to mitigate interruptions to uplink and/or downlink communications. As shown by reference number 656, the network node may transmit an independent BWP switch instruction for the first component carrier in a similar manner as described with regard to FIG. 6A. As shown by reference number 658, the UE may delay performing the independent BWP switching for the first component carrier (e.g., CC0) until a start of the slot N+1 in a similar manner as described with regard to FIG. 6A. Based at least in part on the fourth UE architecture, the UE may perform independent BWP switching that reconfigures a communication chain that processes downlink communications that use the first component carrier without interrupting communications on the uplink communications that use all of the three component carriers 654 and/or downlink communications that use the second component carrier (e.g., CC1) and the third component carrier (e.g., CC2) in the slot N+1 and slot N+2. That is, the UE may continue to transmit and/or receive using the second component carrier, transmit and/or receive using the third component carrier, and/or transmit using the first component carrier in parallel with reconfiguring the BWP of the first component carrier that is used by the UE.

Independent BWP switching for multiple communication chains may enable a network node to leverage a scheduling pattern and instruct a UE to reconfigure a first communication chain during a time partition that is associated with a second communication chain. For example, the network node may instruct a UE to reconfigure a BWP of a downlink communication chain during an uplink time partition (e.g., a time partition in which the downlink communication chain will be unused) to reduce data transfer latencies and/or increase data throughput of the downlink chain (or vice versa). The use of independent BWP switching may also enable the network node to select unlinked BWP configurations for each communication chain used by a UE and/or select respective BWP configurations that are optimized for the communication chain. For instance, the network node may select a first downlink BWP configuration that reduces air interface resource waste based at least in part on a downlink data traffic pattern and/or may select a second BWP configuration (e.g., that is not linked to the first BWP configuration) that reuses air interface resource waste based at least in part on an uplink data traffic pattern. Alternatively, or additionally, the network node may select each BWP configuration to reduce a respective data transfer latency and/or satisfy a QoS operating condition. Mitigating air interface resources waste may reduce data transfer latencies and/or increase data throughput.

As indicated above, FIGS. 6A and 6B are provided as examples. Other examples may differ from what is described with regard to FIGS. 6A and 6B.

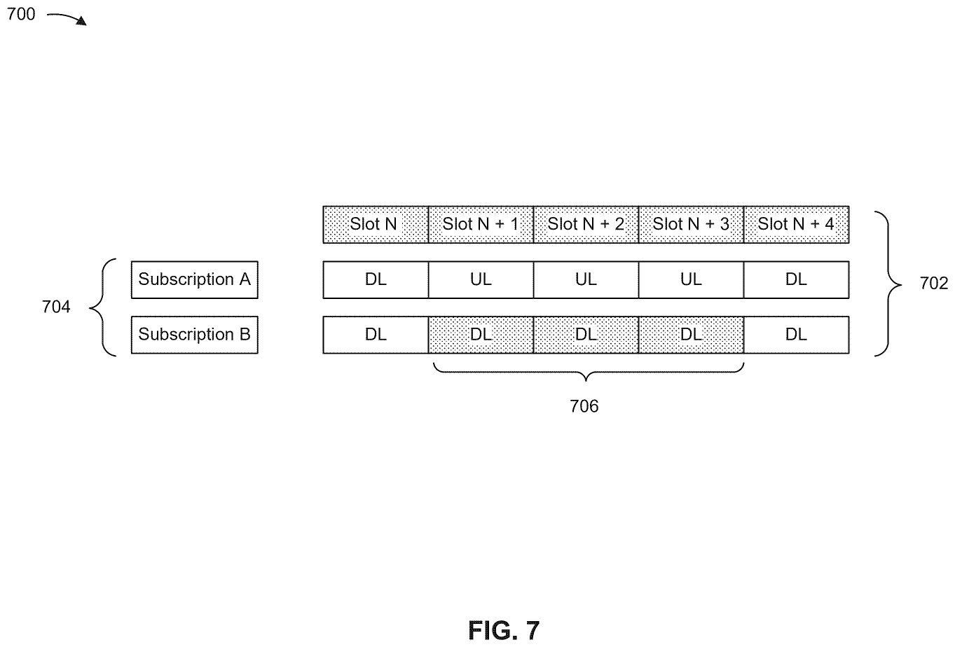

FIG. 7 is a diagram illustrating an example 700 of independent BWP switching that is based at least in part on dual subscriber identity module dual modes, in accordance with the present disclosure.

In dual subscriber identity module (SIM) dual active (DSDA), a UE may maintain two active cellular connections concurrently and/or contemporaneously. In a similar manner, in dual SIM dual connectivity (DSDC), the UE may maintain two cellular connections using a respective SIM card for each cellular connection at the same time. “Dual SIM dual mode” may refer to DSDA and/or DSDC. In dual SIM dual mode cases, an uplink time partition (e.g., a slot, a mini-slot, a half frame, and/or a frame) of a first subscription may overlap with a downlink time partition of a second subscription. In some aspects, a first network node that services the UE via the first subscription may communicate with a second network node that services the UE via the second subscription, such as via a backhaul, and the two network nodes may share scheduling information that may be used by either the first network node or the second network node to schedule independent BWP switching at the UE to mitigate interruptions in uplink communications and/or downlink communications at the UE, reduce data transfer latencies, and/or increased data throughput.

To illustrate, the example 700 includes a dual SIM dual mode scheduling pattern 702 that spans five time partitions, shown by FIG. 7 as slot N, slot N+1, slot N+2, slot N+3, and slot N+4. The dual SIM dual mode scheduling pattern 702 may be associated with two active subscriptions 704 (shown as subscription A and subscription B) at a UE. The first subscription (e.g., subscription A) may be associated with a first network node and the second subscription (e.g., subscription B) may be associated with a second network node. In the dual SIM dual mode scheduling pattern 702, a first network node associated with the first subscription assigns slot N and slot N+4 to downlink communications, and slot N+1, slot N+2, and slot N+3 to uplink communications, and a second network node associated with the second subscription assigns all five time partitions to downlink communications.

In some aspects, a UE that is assigned the dual SIM dual mode scheduling pattern 702 (e.g., by the first network node and the second node) may indicate support for independent BWP switching, such as by indicating support for a Type 3 BWP switching capability, to both the first network node and the second network node during respective initial access procedures and/or based at least in part on receiving a query for UE capability information, such as in a DSDA scenario. Alternatively, or additionally, the UE may indicate support for independent BWP switching to a master cell group master node (MCG/MN), and the MCG/MN may indicate the support for independent BWP switching to a secondary cell group secondary node (SCG/SN), such as via a backhaul in a DSDC scenario. In some aspects, and based at least in part on the UE indicating support for independent BWP switching, the first network node and the second network node may exchange semi-static time partition configuration information (e.g., the scheduling assignments in the dual SIM dual mode scheduling pattern 702 and/or scheduling assignments that are not dynamically adjusted and/or communicated each transmission). For example, the first network node may indicate the scheduling configuration for the first subscription to the second network node, and/or the second network node may indicate the scheduling configuration for the first subscription to the first network node, via a backhaul link.

A UE may implement a hardware protection scheme to mitigate hardware damage in a dual SIM dual mode operating scenario, and the hardware protection schemes may degrade downlink performance (e.g., increase data recovery errors and/or reduced signal power level). For example, the UE may disable a low-noise amplifier during a time span in which an uplink time partition of a first subscription overlaps with a downlink time partition of a second subscription, such as the overlap of the uplink time partitions of the first subscription with the downlink time partitions of the second partitions of the second subscription as shown by reference number 706. In some aspects, disabling the low-noise amplifier may reduce a received signal power level, resulting in increased data recovery errors. Accordingly, based at least in part on the hardware protection scheme degrading downlink performance, the second network node may schedule an independent BWP switch for the downlink time partitions in slot N+1, slot N+2, and slot N+3 (shown with a dotted pattern) that result in overlapping downlink time partitions and uplink time partitions. That is, the second network node may leverage time partitions with expected degradation in downlink performance (e.g., from the second network node) for downlink independent BWP switching and preserve time partitions that do not have expected degradation in downlink performance for downlink communications (e.g., from the second network node), resulting in increased data throughput and/or reduced data transfer latencies relative to scheduling downlink independent BWP switching in other downlink time partitions (e.g., slot N and slot N+4). Accordingly, a UE may perform independent BWP switching for communication chains that are associated with different (active) subscriptions, and network nodes may use shared semi-static scheduling information to mitigate a reduction in data throughput and/or an increase in data transfer latencies.

As indicated above, FIG. 7 is provided as an example. Other examples may differ from what is described with regard to FIG. 7.

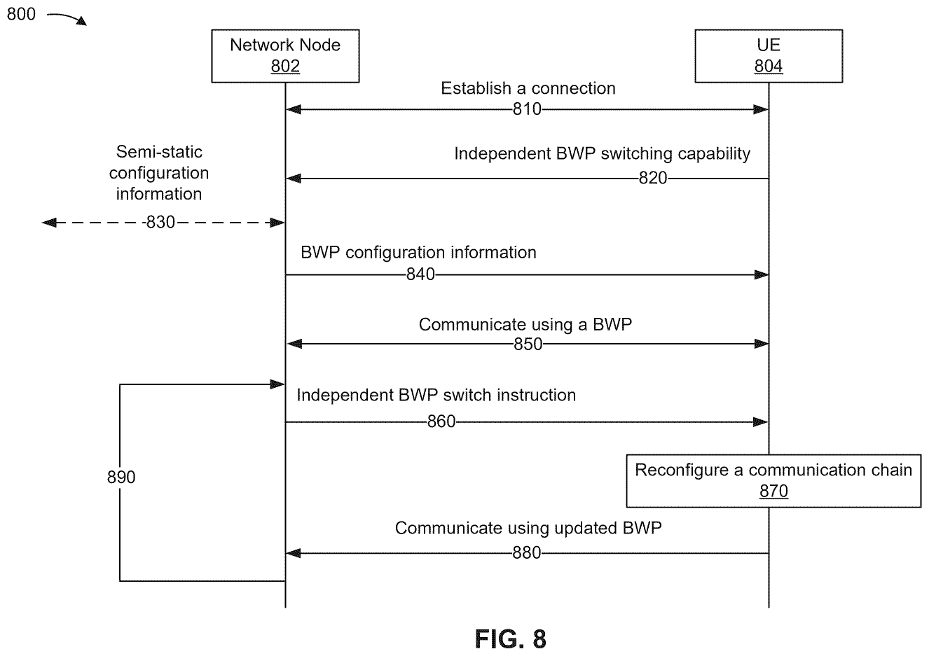

FIG. 8 is a diagram illustrating an example 800 of a wireless communication process between a network node 802 (e.g., the network node 110) and a UE 804 (e.g., the UE 120), in accordance with the present disclosure.

As shown by reference number 810, a network node 802 and a UE 804 may establish a connection. To illustrate, the UE 804 may power up in a cell coverage area provided by the network node 802, and the UE 804 and the network node 802 may perform one or more procedures (e.g., a random access channel (RACH) procedure and/or an RRC procedure) to establish a wireless connection. As another example, the UE 804 may move into the cell coverage area provided by the network node 802 and may perform a handover from a source network node (e.g., another network node 110) to the network node 802. Alternatively, or additionally, the network node 802 and the UE 804 may communicate via the connection based at least in part on any combination of Layer 1 signaling (e.g., DCI and/or UCI), Layer 2 signaling (e.g., a MAC control element (CE)), and/or Layer 3 signaling (e.g., RRC signaling). To illustrate, the network node 802 may request, via RRC signaling, UE capability information and/or the UE 804 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 802 may transmit the configuration information via Layer 3 signaling at a first point in time associated with the UE 804 being tolerant of communication delays, and the network node 802 may transmit an activation of the configuration via Layer 2 signaling and/or Layer 1 signaling at a second point in time associated with the UE 804 being intolerant to communication delays.

As shown by reference number 820, the UE 804 may transmit, and the network node 802 may receive, an indication of an independent BWP switching capability. As one example, the UE 804 may indicate support for independent BWP switching in UE capability information, such as by indicating support for Type 3 BWP switching (e.g., support for independently modifying a BWP configuration of a first communication chain without modifying a second communication chain). Alternatively, or additionally, the UE 804 may indicate a trigger time offset that is associated with independently modifying the BWP configuration of a first communication chain (e.g., without modifying a second communication chain), and the trigger time offset may indicate a triggering delay that is supported by the UE for triggering independent BWP switching. In some aspects, the UE 804 may indicate BWP switching time information (e.g., an amount of time that the UE 804 uses to perform independent BWP switching and/or to reconfigure a BWP of a communication chain). The UE 804 may indicate one or more BWP switching times, such as a general BWP switching time that is applicable to multiple communication chains, a receiver BWP switching time that is specific to a receiver communication chain, and/or a transmitter BWP switching time that is specific to a transmitter communication chain.

The UE 804 may indicate (e.g., in UE capability information) a frequency band combination with a first potential of interruption during an independent BWP switch, a cell combination with a second potential of interruption during the independent BWP switch, and/or a component carrier trigger time offset associated with the independent BWP switch as described with regard to FIGS. 6A and 6B. That is, the UE 804 may indicate one or more combinations of linked frequency bands and/or linked cells that may affect one another during an independent BWP switch. As part of indicating a cell combination and/or a frequency band combination, the UE 804 may indicate an association communication direction (e.g., uplink, downlink, transmission, and/or reception). Alternatively, or additionally, the UE 804 may indicate, as the component carrier trigger time offset, a component carrier trigger time offset is scalable based at least in part on a number of component carriers. In some aspects, the UE 804 may indicate a base component carrier trigger time offset and a relative component trigger time offset, where the relative component trigger time offset is scalable based at least in part on a number of component carriers.

For clarity, FIG. 8 illustrates the UE 804 transmitting the indication of the independent BWP switching capability information in a separate transaction than establishing a connection with the network node 802 in the example 800. However, in some aspects, the UE 804 may transmit the indication of independent BWP switching capability as part of establishing a connection with the network node 802. For instance, the UE 804 may indicate any combination of the independent BWP switching capability information as described above in UE capability information that is transmitted by the UE 804 as part of establishing the connection with the network node 802.

As shown by reference number 830, the network node 802 may transmit and/or receive semi-static configuration information. For example, the network node 802 may be a first network node (e.g., a first network node 110) that provides service for a first subscription of the UE 804, and the network node 802 may transmit first semi-static configuration to, and/or receive second semi-static configuration information from, a second network node that provides service for a second subscription of the UE 804 as described with regard to FIG. 7. While FIG. 8 illustrates the network node 802 transmitting and/or receiving semi-static configuration information, the example 800 and/or other examples may not include the network node 802 transmitting and/or receiving semi-static configuration information (further denoted in FIG. 8 through the use of a dashed line).

As shown by reference number 840, the network node 802 may transmit, and the UE may receive, BWP configuration information. The network node 802 may transmit the BWP configuration information in multiple signaling transactions. For instance, the network node 802 may transmit a set of downlink BWP configurations and/or a set of uplink BWP configurations in Layer 3 signaling (e.g., RRC signaling), and selection of a particular downlink BWP configuration and/or an uplink BWP configuration in Layer 1 signaling (e.g., DCI).

As shown by reference number 850, the network node 802 and the UE 804 may communicate using one or more BWPs. For example, the network node 802 may transmit, and the UE 804 may receive, a downlink communication in a downlink BWP. Alternatively, or additionally, the UE 804 may transmit, and the network node 802 may receive, an uplink communication in an uplink BWP. In some aspects, the downlink BWP and the uplink BWP may be in a same carrier. The UE 804 may alternatively, or additionally, use one or more BWPs to communicated with another UE (e.g., another UE 110) via a sidelink, such as by using a first BWP for sidelink transmission and a second BWP for sidelink reception.

As shown by reference number 860, the network node 802 may transmit, and the UE 804 may receive, an indication of an independent BWP switch instruction, and the independent BWP switch instruction may indicate to reconfigure a BWP used by a first communication chain without reconfiguring a second communication chain. As one example, the first communication chain may initially be configured to process a first BWP in a carrier and a second communication chain may initially be configured to process a second BWP in the same carrier. The independent BWP switch instruction may indicate to reconfigure the first communication chain to use a third BWP in the carrier without reconfiguring the second communication chain. In some aspects, the first communication chain may be a downlink communication chain and the second communication chain may be an uplink communication chain (or vice versa). Alternatively, or additionally, the first communication chain may be a transmitter communication chain and the second communication chain may be a receiver communication chain (or vice versa). In some aspects, the first communication chain may be associated with a first active subscription, and the second communication chain may be associated with a second active subscription. Alternatively, or additionally, the first communication chain may be configured for a first BWP in a carrier and the second communication chain may be configured for a second BWP in the same carrier.

The network node 802 may transmit the indication of the independent BWP switch instruction in Layer 1 signaling (e.g., DCI), Layer 2 signaling (e.g., a MAC CE), and/or Layer 3 signaling (e.g., RRC signaling). The network node 802 may transmit and/or configure the independent BWP switch instruction based at least in part on a scheduling pattern, such as the scheduling pattern 502, the scheduling pattern 562, the scheduling pattern 602, the scheduling pattern 652, and/or the scheduling pattern 702 described above. The scheduling pattern may include at least a first time partition that is associated with the first communication chain and a second time partition that is associated with the second communication chain. Example time partitions may include a downlink time partition, an uplink time partition, a transmitter time partition, and/or a receiver time partition. The network node 802 may select a first communication chain to reconfigure based at least in part on the scheduling pattern and/or the network node 802 may indicate, via the independent BWP switch instruction, to reconfigure the first communication chain during at least part of a time partition that is associated with a second communication chain. For instance, the first communication chain may be a downlink communication chain and the second communication chain may be an uplink communication chain, and the independent BWP switch may indicate to reconfigure a BWP of the downlink communication chain during an uplink time partition (or vice versa with an uplink communication chain, a downlink communication chain, and a downlink time partition).

In some aspects, the network node 802 may transmit an indication of a resource grant, and the network node 802 may configure the resource grant based at least in part on independent BWP switching. For instance, the network node 802 may transmit the indication of the resource grant in DCI, and the network node 802 may select a configuration that mitigates interruption to a communication chain. To illustrate, as described with regard to FIG. 5C, the resource grant may include a flexible slot, and the network node may indicate a communication direction configuration for the flexible slot to mitigate interruptions to a communication chain. The network node 802 may determine to configure the flexible slot based at least in part on BWP switching time information from the UE 804. Based at least in part on receiving the independent BWP switching instruction, the UE 804 may activate a timer, such as a timer is configured with a trigger time offset.

As shown by reference number 870, the UE 804 may reconfigure a communication chain. For instance, based at least in part on receiving an instruction to reconfiguring a BWP of a first communication chain, the UE 804 may reconfigure the first communication chain to use the BWP indicated in the independent BWP switching instruction. In some aspects, as described with regard to FIGS. 5A, 5B, 5C, 6A, 6B, and 7, the UE 804 may reconfigure the first communication chain during at least part of a second time partition that is associated with a second communication chain. In some aspects, the UE 804 may blank the first communication chain during at least part of the reconfiguration (e.g., during at least part of the second time partition). Alternatively, or additionally, the UE 804 may process one or more communications using the second communication chain and/or may not black the second communication chain (e.g., during the reconfiguration of the first communication chain and/or during at least part of the second time partition). For example, the first communication chain may be a receiver communication chain, the second communication chain may be a transmitter communication chain, and the UE 804 may process a transmission using the transmitter communication chain during reconfiguration of the receiver communication chain (or vice versa for the receiver communication chain and the transmitter communication chain). In some aspects, the UE 804 may trigger the reconfiguration of a communication chain based at least in part on expiration of a timer (e.g., a trigger time offset timer). Based at least in part on performing the independent BWP switching, the UE 804 may operate with at least two communication chains that are configured with respective BWPs of a same carrier that are not linked BWPs (e.g. not linked with a same BWP ID and/or same index).

As shown by reference number 880, the network node 802 and the UE 804 may communication using the updated BWP. For instance, based at least in part on changing a downlink BWP, the network node 802 may transmit, and the UE 804 may receive, a downlink transmission that uses the updated BWP. In the scenario with an updated downlink BWP, the network node 802 and the UE 804 may continue to use the unchanged uplink BWP for an uplink transmission. Based at least in part on changing an uplink BWP, the UE 804 may transmit, and the network node 802 may receive an uplink transmission that uses the updated BWP. In the scenario with an updated uplink BWP, the network node 802 and the UE 804 may continue to use the unchanged downlink BWP for a downlink transmission. However, in some examples, the UE 804 may communicate via a sidelink using the updated BWP, such as by transmitting using an updated transmitter BWP (and receiving using an unchanged receiver BWP) and/or receiving using an updated receiver BWP (and transmitting using an unchanged transmitter BWP).

As shown by reference number 890, the network node 802 and/or the UE 804 may iteratively perform one or more aspects of the process 800. For instance, the network node 802 may determine to update a downlink BWP, an uplink BWP, a transmitter BWP, and/or a receiver BWP. Accordingly, the network node 802 may transmit an independent BWP switch instruction, the UE 804 may reconfigure a communication chain that is associated with the independent BWP switch instruction, and/or the network node 802 and the UE 804 may communicate using the updated BWP. In some aspects, the network node 802 may iteratively transmit and/or receive semi-static configuration information in a similar manner as described with regard to reference number 830).

Independent BWP switching for multiple communication chains may enable a network node to leverage a scheduling pattern and instruct a UE to reconfigure a first communication chain during a time partition that is associated with a second communication chain. For example, the network node may instruct a UE to reconfigure a BWP of a downlink communication chain during an uplink time partition (e.g., a time partition in which the downlink communication chain will be unused) to reduce data transfer latencies and/or increase data throughput of the downlink chain (or vice versa). The use of independent BWP switching may also enable the network node to select unlinked BWP configurations for each communication chain used by a UE and/or select respective BWP configurations that are optimized for the communication chain. For instance, the network node may select a first downlink BWP configuration that reduces air interface resource waste based at least in part on a downlink data traffic pattern and/or may select a second BWP configuration (e.g., that is not linked to the first BWP configuration) that reuses air interface resource waste based at least in part on an uplink data traffic pattern. Alternatively, or additionally, the network node may select each BWP configuration to reduce a respective data transfer latency and/or satisfy a Qos operating condition. Mitigating air interface resources waste may reduce data transfer latencies and/or increase data throughput.

As indicated above. FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with configuring a first communication chain for a BWP change without modifying a second communication chain.

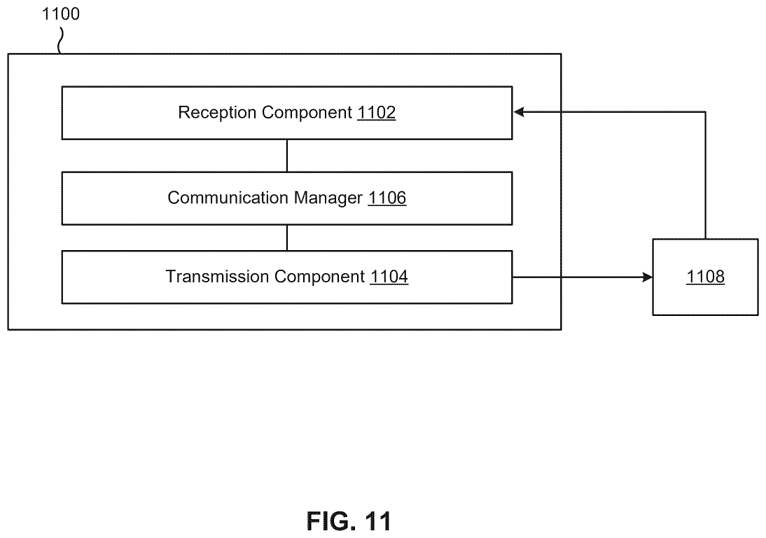

As shown in FIG. 9, in some aspects, process 900 may include transmitting UE capability information that indicates support for independently modifying a BWP configuration of a first communication chain that is configured with a first BWP in a carrier without modifying a second communication chain that is configured with a second BWP in the carrier (block 910). For example, the UE (e.g., using transmission component 1104 and/or communication manager 1106, depicted in FIG. 11) may transmit UE capability information that indicates support for independently modifying a BWP configuration of a first communication chain that is configured with a first BWP in a carrier without modifying a second communication chain that is configured with a second BWP in the carrier, as described above.

As further shown in FIG. 9, in some aspects, process 900 may include receiving, based at least in part on indicating support for independently modifying the BWP configuration of the first communication chain without modifying the second communication chain, an instruction to reconfigure the first communication chain with a third BWP in the carrier without modifying the second communication chain (block 920). For example, the UE (e.g., using reception component 1102 and/or communication manager 1106, depicted in FIG. 11) may receive, based at least in part on indicating support for independently modifying the BWP configuration of the first communication chain without modifying the second communication chain, an instruction to reconfigure the first communication chain with a third BWP in the carrier without modifying the second communication chain, as described above.

Process 900 may include additional aspects, such as any single aspect or any combination of aspects described below and/or in connection with one or more other processes described elsewhere herein.

In a first aspect, the instruction to reconfigure the first communication chain is based at least in part on a scheduling pattern that includes at least a first time partition that is associated with the first communication chain and a second time partition that is associated with the second communication chain, and the instruction to reconfigure the first communication chain indicates to reconfigure the first communication chain during at least part of the second time partition.

In a second aspect, process 900 includes reconfiguring the first communication chain to process the third BWP during the at least part of the second time partition.

In a third aspect, process 900 includes blanking the first communication chain during the at least part of the second time partition, and processing a transmission using the second communication chain and during the at least part of the second time partition.

In a fourth aspect, the first communication chain is a receiver communication chain, the second communication chain is a transmitter communication chain, and processing the transmission includes transmitting the transmission based at least in part on using the transmitter communication chain.

In a fifth aspect, the first communication chain is a transmitter communication chain, the second communication chain is a receiver communication chain, and processing the transmission includes receiving the transmission based at least in part on using the receiver communication chain.

In a sixth aspect, process 900 includes the first time partition is a downlink time partition and the second time partition is an uplink time partition, or the first time partition is the uplink time partition and the second time partition is the downlink time partition.

In a seventh aspect, receiving the instruction includes receiving the instruction in downlink control information.

In an eighth aspect, the UE capability information indicates a trigger time offset that is associated with independently modifying the BWP configuration of the first communication chain without modifying the second communication chain, and process 900 includes activating a timer that is configured with the trigger time offset based at least in part on receiving the instruction, and initiating reconfiguration of the first communication chain based at least in part on expiration of the timer.

In a ninth aspect, the UE capability information indicates support for Type 3 BWP switching that indicates the support for independently modifying the BWP configuration of the first communication chain without modifying the second communication chain.

In a tenth aspect, the UE capability information indicates BWP switching time information.

In an eleventh aspect, the BWP switching time information indicates at least one of a receiver BWP switching time, a transmitter BWP switching time, or a general BWP switching time.

In a twelfth aspect, process 900 includes receiving a resource grant that is based at least in part on the BWP switching time information, the resource grant indicating a flexible slot configuration.

In a thirteenth aspect, the UE capability information indicates at least one of a frequency band combination with a first potential of interruption during an independent BWP switch, a cell combination with a second potential of interruption during the independent BWP switch, or a component carrier trigger time offset associated with the independent BWP switch.

In a fourteenth aspect, the component carrier trigger time offset is scalable based at least in part on a number of component carriers.

In a fifteenth aspect, the cell combination indicates a first cell and a first communication direction of the first cell, and a second cell and a second communication direction of the second cell.

In a sixteenth aspect, the first communication chain is associated with a first active subscription, and the second communication chain is associated with a second active subscription.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., a network node 110) performs operations associated with configuring a first communication chain for a BWP change without modifying a second communication chain.

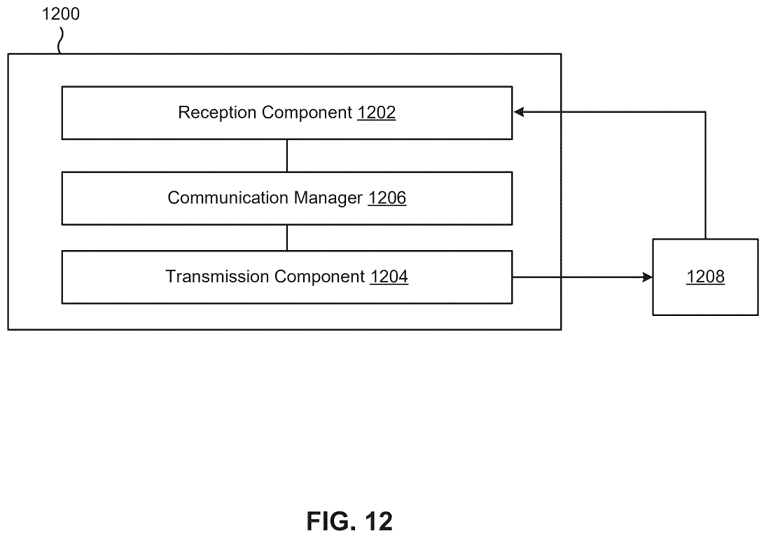

As shown in FIG. 10, in some aspects, process 1000 may include receiving UE capability information that indicates support for independently modifying a BWP configuration of a first communication chain that is configured with a first BWP in a carrier without modifying a second communication chain that is configured with a second BWP in the carrier (block 1010). For example, the network node (e.g., using reception component 1202 and/or communication manager 1206, depicted in FIG. 12) may receive UE capability information that indicates support for independently modifying a BWP configuration of a first communication chain that is configured with a first BWP in a carrier without modifying a second communication chain that is configured with a second BWP in the carrier, as described above.

As further shown in FIG. 10, in some aspects, process 1000 may include transmitting, based at least in part on receiving an indication of the support for independently modifying the BWP configuration of the first communication chain without modifying the second communication chain, an instruction to reconfigure the first communication chain with a third BWP in the carrier without modifying the second communication chain (block 1020). For example, the network node (e.g., using transmission component 1204 and/or communication manager 1206, depicted in FIG. 12) may transmit, based at least in part on receiving an indication of the support for independently modifying the BWP configuration of the first communication chain without modifying the second communication chain, an instruction to reconfigure the first communication chain with a third BWP in the carrier without modifying the second communication chain, as described above.

Process 1000 may include additional aspects, such as any single aspect or any combination of aspects described below and/or in connection with one or more other processes described elsewhere herein.

In a first aspect, the instruction to reconfigure the first communication chain is based at least in part on a scheduling pattern that includes at least a first time partition that is associated with the first communication chain and a second time partition that is associated with the second communication chain, and the instruction to reconfigure the first communication chain indicates to reconfigure the first communication chain during at least part of the second time partition.

In a second aspect, process 1000 includes the first time partition is a downlink time partition and the second time partition is an uplink time partition, or the first time partition is the uplink time partition and the second time partition is the downlink time partition.

In a third aspect, transmitting the instruction includes transmitting the instruction in downlink control information.

In a fourth aspect, the UE capability information indicates a trigger time offset that is associated with independently modifying the BWP configuration of the first communication chain without modifying the second communication chain.

In a fifth aspect, the UE capability information indicates support for Type 3 BWP switching that indicates the support for independently modifying the BWP configuration of the first communication chain without modifying the second communication chain.

In a sixth aspect, the UE capability information indicates BWP switching time information.

In a seventh aspect, the BWP switching time information indicates at least one of a receiver BWP switching time, a transmitter BWP switching time, or a general BWP switching time.

In an eighth aspect, process 1000 includes configuring a flexible slot in a resource grant based at least in part on the BWP switching time information, and transmitting an indication of resource grant.

In a ninth aspect, the UE capability information indicates at least one of a frequency band combination with a first potential of interruption during an independent BWP switch, a cell combination with a second potential of interruption during the independent BWP switch, or a component carrier trigger time offset associated with the independent BWP switch.

In a tenth aspect, the component carrier trigger time offset is scalable based at least in part on a number of component carriers.

In an eleventh aspect, the cell combination indicates a first cell and a first communication direction of the first cell, and a second cell and a second communication direction of the second cell.

In a twelfth aspect, the first communication chain is associated with a first active subscription, and the second communication chain is associated with a second active subscription.

In a thirteenth aspect, the network node is a first network node, process 1000 includes receiving semi-static slot configuration information from a second network node, and the instruction to reconfigure the first communication chain is based at least in part on the semi-static slot configuration information from the second network node.

In a fourteenth aspect, transmitting the instruction to reconfigure the first communication chain includes transmitting the instruction based at least in part on a scheduling pattern that includes a first time partition that is associated with the first communication chain and a second time partition that is associated with the second communication chain.

In a fifteenth aspect, the scheduling pattern includes a time partition that is associated with the second communication chain, and the instruction indicates to reconfigure the first communication chain during at least part of the second time partition that is associated with the second communication chain.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE (e.g., a UE 120), or a UE (e.g., a UE 120) may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit UE capability information that indicates support for independently modifying a BWP configuration of a first communication chain that is configured with a first BWP in a carrier without modifying a second communication chain that is configured with a second BWP in the carrier. The reception component 1102 may receive, based at least in part on indicating support for independently modifying the BWP configuration of the first communication chain without modifying the second communication chain, an instruction to reconfigure the first communication chain with a third BWP in the carrier without modifying the second communication chain.

The communication manager 1106 may reconfigure the first communication chain to process the third BWP during the at least part of the second time partition. In some aspects, the communication manager 1106 may blank the first communication chain during the at least part of the second time partition. Alternatively, or additionally, the communication manager 1106 may process a transmission using the second communication chain and during the at least part of the second time partition. In some aspects, reception component 1102 may receive a resource grant that is based at least in part on the BWP switching time information, the resource grant indicating a flexible slot configuration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive UE capability information that indicates support for independently modifying a BWP configuration of a first communication chain that is configured with a first BWP in a carrier without modifying a second communication chain that is configured with a second BWP in the carrier. The transmission component 1204 may transmit, based at least in part on receiving an indication of the support for independently modifying the BWP configuration of the first communication chain without modifying the second communication chain, an instruction to reconfigure the first communication chain with a third BWP in the carrier without modifying the second communication chain.

The communication manager 1206 may configure a flexible slot in a resource grant based at least in part on the BWP switching time information. Alternatively, or additionally, the transmission component 1204 may transmit an indication of resource grant.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: transmitting UE capability information that indicates support for independently modifying a bandwidth part (BWP) configuration of a first communication chain that is configured with a first BWP in a carrier without modifying a second communication chain that is configured with a second BWP in the carrier; and receiving, based at least in part on indicating support for independently modifying the BWP configuration of the first communication chain without modifying the second communication chain, an instruction to reconfigure the first communication chain with a third BWP in the carrier without modifying the second communication chain.

Aspect 2: The method of Aspect 1, wherein the instruction to reconfigure the first communication chain is based at least in part on a scheduling pattern that includes at least a first time partition that is associated with the first communication chain and a second time partition that is associated with the second communication chain, and wherein the instruction to reconfigure the first communication chain indicates to reconfigure the first communication chain during at least part of the second time partition.

Aspect 3: The method of Aspect 2, further comprising: reconfiguring the first communication chain to process the third BWP during the at least part of the second time partition.

Aspect 4: The method of Aspect 3, further comprising: blanking the first communication chain during the at least part of the second time partition; and processing a transmission using the second communication chain and during the at least part of the second time partition.

Aspect 5: The method of any of Aspects 1-4, wherein the first communication chain is a receiver communication chain, wherein the second communication chain is a transmitter communication chain, and wherein processing the transmission comprises: transmitting the transmission based at least in part on using the transmitter communication chain.

Aspect 6: The method of any of Aspects 1-4, wherein the first communication chain is a transmitter communication chain, wherein the second communication chain is a receiver communication chain, and wherein processing the transmission comprises: receiving the transmission based at least in part on using the receiver communication chain.

Aspect 7: The method of Aspect 2, wherein: the first time partition is a downlink time partition and the second time partition is an uplink time partition, or the first time partition is the uplink time partition and the second time partition is the downlink time partition.

Aspect 8: The method of any of Aspects 1-7, wherein receiving the instruction comprises: receiving the instruction in downlink control information.

Aspect 9: The method of any of Aspects 1-8, wherein the UE capability information indicates a trigger time offset that is associated with independently modifying the BWP configuration of the first communication chain without modifying the second communication chain, and wherein the method further comprises: activating a timer that is configured with the trigger time offset based at least in part on receiving the instruction; and initiating reconfiguration of the first communication chain based at least in part on expiration of the timer.

Aspect 10: The method of any of Aspects 1-9, wherein the UE capability information indicates support for Type 3 BWP switching that indicates the support for independently modifying the BWP configuration of the first communication chain without modifying the second communication chain.

Aspect 11: The method of any of Aspects 1-10, wherein the UE capability information indicates BWP switching time information.

Aspect 12: The method of Aspect 11, where the BWP switching time information indicates at least one of: a receiver BWP switching time, a transmitter BWP switching time, or a general BWP switching time.

Aspect 13: The method of Aspect 11, further comprising: receiving a resource grant that is based at least in part on the BWP switching time information, the resource grant indicating a flexible slot configuration.

Aspect 14: The method of any of Aspects 1-13, wherein the UE capability information indicates at least one of: a frequency band combination with a first potential of interruption during an independent BWP switch, a cell combination with a second potential of interruption during the independent BWP switch, or a component carrier trigger time offset associated with the independent BWP switch.

Aspect 15: The method of Aspect 14, wherein the component carrier trigger time offset is scalable based at least in part on a number of component carriers.

Aspect 16: The method of Aspect 14, wherein the cell combination indicates: a first cell and a first communication direction of the first cell, and a second cell and a second communication direction of the second cell.

Aspect 17: The method of any of Aspects 1-16, wherein the first communication chain is associated with a first active subscription, and wherein the second communication chain is associated with a second active subscription.

Aspect 18: A method of wireless communication performed by a network node, comprising: receiving user equipment (UE) capability information that indicates support for independently modifying a bandwidth part (BWP) configuration of a first communication chain that is configured with a first BWP in a carrier without modifying a second communication chain that is configured with a second BWP in the carrier; and transmitting, based at least in part on receiving an indication of the support for independently modifying the BWP configuration of the first communication chain without modifying the second communication chain, an instruction to reconfigure the first communication chain with a third BWP in the carrier without modifying the second communication chain.

Aspect 19: The method of Aspect 18, wherein the instruction to reconfigure the first communication chain is based at least in part on a scheduling pattern that includes at least a first time partition that is associated with the first communication chain and a second time partition that is associated with the second communication chain, and wherein the instruction to reconfigure the first communication chain indicates to reconfigure the first communication chain during at least part of the second time partition.

Aspect 20: The method of Aspect 19, wherein: the first time partition is a downlink time partition and the second time partition is an uplink time partition, or the first time partition is the uplink time partition and the second time partition is the downlink time partition.

Aspect 21: The method of any of Aspects 18-20, wherein transmitting the instruction comprises: transmitting the instruction in downlink control information.

Aspect 22: The method of any of Aspects 18-21, wherein the UE capability information indicates a trigger time offset that is associated with independently modifying the BWP configuration of the first communication chain without modifying the second communication chain.

Aspect 23: The method of any of Aspects 18-22, wherein the UE capability information indicates support for Type 3 BWP switching that indicates the support for independently modifying the BWP configuration of the first communication chain without modifying the second communication chain.

Aspect 24: The method of any of Aspects 18-23, wherein the UE capability information indicates BWP switching time information.

Aspect 25: The method of Aspect 24, where the BWP switching time information indicates at least one of: a receiver BWP switching time, a transmitter BWP switching time, or a general BWP switching time.

Aspect 26: The method of Aspect 24, further comprising: configuring a flexible slot in a resource grant based at least in part on the BWP switching time information; and transmitting an indication of resource grant.

Aspect 27: The method of any of Aspects 18-26, wherein the UE capability information indicates at least one of: a frequency band combination with a first potential of interruption during an independent BWP switch, a cell combination with a second potential of interruption during the independent BWP switch, or a component carrier trigger time offset associated with the independent BWP switch.

Aspect 28: The method of Aspect 27, wherein the component carrier trigger time offset is scalable based at least in part on a number of component carriers.

Aspect 29: The method of Aspect 27, wherein the cell combination indicates: a first cell and a first communication direction of the first cell, and a second cell and a second communication direction of the second cell.

Aspect 30: The method of any of Aspects 18-29, wherein the first communication chain is associated with a first active subscription, and wherein the second communication chain is associated with a second active subscription.

Aspect 31: The method of Aspect 30, wherein the network node is a first network node, and wherein the method further comprises: receiving semi-static slot configuration information from a second network node, wherein the instruction to reconfigure the first communication chain is based at least in part on the semi-static slot configuration information from the second network node.

Aspect 32: The method of any of Aspects 18-31, wherein transmitting the instruction to reconfigure the first communication chain comprises: transmitting the instruction based at least in part on a scheduling pattern that includes a first time partition that is associated with the first communication chain and a second time partition that is associated with the second communication chain.

Aspect 33: The method of Aspect 32, wherein the scheduling pattern includes a time partition that is associated with the second communication chain, and wherein the instruction indicates to reconfigure the first communication chain during at least part of the second time partition that is associated with the second communication chain.

Aspect 34: An apparatus for wireless communication at a device, the apparatus comprising one or more processors: one or more memories coupled with the one or more processors; and instructions stored in the one or more memories and executable by the one or more processors to cause the apparatus to perform the method of one or more of Aspects 1-17.

Aspect 35: An apparatus for wireless communication at a device, the apparatus comprising one or more memories and one or more processors coupled to the one or more memories, the one or more processors configured to cause the device to perform the method of one or more of Aspects 1-17.

Aspect 36: An apparatus for wireless communication, the apparatus comprising at least one means for performing the method of one or more of Aspects 1-17.

Aspect 37: A non-transitory computer-readable medium storing code for wireless communication, the code comprising instructions executable by one or more processors to perform the method of one or more of Aspects 1-17.

Aspect 38: A non-transitory computer-readable medium storing a set of instructions for wireless communication, the set of instructions comprising one or more instructions that, when executed by one or more processors of a device, cause the device to perform the method of one or more of Aspects 1-17.

Aspect 39: A device for wireless communication, the device comprising a processing system that includes one or more processors and one or more memories coupled with the one or more processors, the processing system configured to cause the device to perform the method of one or more of Aspects 1-17.

Aspect 40: An apparatus for wireless communication at a device, the apparatus comprising one or more memories and one or more processors coupled to the one or more memories, the one or more processors individually or collectively configured to cause the device to perform the method of one or more of Aspects 1-17.

Aspect 41: An apparatus for wireless communication at a device, the apparatus comprising one or more processors: one or more memories coupled with the one or more processors; and instructions stored in the one or more memories and executable by the one or more processors to cause the apparatus to perform the method of one or more of Aspects 18-33.

Aspect 42: An apparatus for wireless communication at a device, the apparatus comprising one or more memories and one or more processors coupled to the one or more memories, the one or more processors configured to cause the device to perform the method of one or more of Aspects 18-33.

Aspect 43: An apparatus for wireless communication, the apparatus comprising at least one means for performing the method of one or more of Aspects 18-33.

Aspect 44: A non-transitory computer-readable medium storing code for wireless communication, the code comprising instructions executable by one or more processors to perform the method of one or more of Aspects 18-33.

Aspect 45: A non-transitory computer-readable medium storing a set of instructions for wireless communication, the set of instructions comprising one or more instructions that, when executed by one or more processors of a device, cause the device to perform the method of one or more of Aspects 18-33.

Aspect 46: A device for wireless communication, the device comprising a processing system that includes one or more processors and one or more memories coupled with the one or more processors, the processing system configured to cause the device to perform the method of one or more of Aspects 18-33.

Aspect 47: An apparatus for wireless communication at a device, the apparatus comprising one or more memories and one or more processors coupled to the one or more memories, the one or more processors individually or collectively configured to cause the device to perform the method of one or more of Aspects 18-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
transmit UE capability information that indicates support for independently modifying a bandwidth part (BWP) configuration of a first communication chain that is configured with a first BWP in a carrier without modifying a second communication chain that is configured with a second BWP in the carrier; and
receive, based at least in part on indicating support for independently modifying the BWP configuration of the first communication chain without modifying the second communication chain, an instruction to reconfigure the first communication chain with a third BWP in the carrier without modifying the second communication chain.

2. The apparatus of claim 1, wherein the instruction to reconfigure the first communication chain is based at least in part on a scheduling pattern that includes at least a first time partition that is associated with the first communication chain and a second time partition that is associated with the second communication chain, and
wherein the instruction to reconfigure the first communication chain indicates to reconfigure the first communication chain during at least part of the second time partition.

3. The apparatus of claim 2, wherein:
the first time partition is a downlink time partition and the second time partition is an uplink time partition, or
the first time partition is the uplink time partition and the second time partition is the downlink time partition.

4. The apparatus of claim 2, wherein the UE capability information indicates a trigger time offset that is associated with independently modifying the BWP configuration of the first communication chain without modifying the second communication chain, and
wherein the one or more processors are further configured to cause the UE to:
activate a timer that is configured with the trigger time offset based at least in part on receiving the instruction; and
initiate reconfiguration of the first communication chain based at least in part on expiration of the timer.

5. The apparatus of claim 2, wherein the UE capability information indicates support for Type 3 BWP switching that indicates the support for independently modifying the BWP configuration of the first communication chain without modifying the second communication chain.

6. The apparatus of claim 1, wherein the UE capability information indicates BWP switching time information.

7. The apparatus of claim 1, wherein the UE capability information indicates at least one of:
a frequency band combination with a first potential of interruption during an independent BWP switch,
a cell combination with a second potential of interruption during the independent BWP switch, or
a component carrier trigger time offset associated with the independent BWP switch.

8. The apparatus of claim 1, wherein the first communication chain is associated with a first active subscription, and
wherein the second communication chain is associated with a second active subscription.

9. An apparatus for wireless communication at a network node, comprising:
one or more memories; and
one or more processors, coupled to the one or more memories, configured to cause the network node to:
receive user equipment (UE) capability information that indicates support for independently modifying a bandwidth part (BWP) configuration of a first communication chain that is configured with a first BWP in a carrier without modifying a second communication chain that is configured with a second BWP in the carrier; and
transmit, based at least in part on receiving an indication of the support for independently modifying the BWP configuration of the first communication chain without modifying the second communication chain, an instruction to reconfigure the first communication chain with a third BWP in the carrier without modifying the second communication chain.

10. The apparatus of claim 9, wherein the instruction to reconfigure the first communication chain is based at least in part on a scheduling pattern that includes at least a first time partition that is associated with the first communication chain and a second time partition that is associated with the second communication chain, and
wherein the instruction to reconfigure the first communication chain indicates to reconfigure the first communication chain during at least part of the second time partition.

11. The apparatus of claim 9, wherein the UE capability information indicates a trigger time offset that is associated with independently modifying the BWP configuration of the first communication chain without modifying the second communication chain.

12. The apparatus of claim 9, wherein the UE capability information indicates support for Type 3 BWP switching that indicates the support for independently modifying the BWP configuration of the first communication chain without modifying the second communication chain.

13. The apparatus of claim 9, wherein the UE capability information indicates BWP switching time information.

14. The apparatus of claim 9, wherein the UE capability information indicates at least one of:
a frequency band combination with a first potential of interruption during an independent BWP switch,
a cell combination with a second potential of interruption during the independent BWP switch, or
a component carrier trigger time offset associated with the independent BWP switch.

15. The apparatus of claim 14, wherein the component carrier trigger time offset is scalable based at least in part on a number of component carriers.

16. The apparatus of claim 14, wherein the cell combination indicates:
a first cell and a first communication direction of the first cell, and
a second cell and a second communication direction of the second cell.

17. The apparatus of claim 9, wherein the first communication chain is associated with a first active subscription, and
wherein the second communication chain is associated with a second active subscription.

18. The apparatus of claim 17, wherein the network node is a first network node, and
wherein the one or more processors are further configured to cause the network node to:
receive semi-static slot configuration information from a second network node,
wherein the instruction to reconfigure the first communication chain is based at least in part on the semi-static slot configuration information from the second network node.

19. The apparatus of claim 9, wherein the one or more processors, to cause the network node to transmit the instruction to reconfigure the first communication chain, are configured to cause the network node to:
transmit the instruction based at least in part on a scheduling pattern that includes a first time partition that is associated with the first communication chain and a second time partition that is associated with the second communication chain.

20. The apparatus of claim 19, wherein the scheduling pattern includes a time partition that is associated with the second communication chain, and
wherein the instruction indicates to reconfigure the first communication chain during at least part of the second time partition that is associated with the second communication chain.

21. A method of wireless communication performed by a user equipment (UE), comprising:
transmitting UE capability information that indicates support for independently modifying a bandwidth part (BWP) configuration of a first communication chain that is configured with a first BWP in a carrier without modifying a second communication chain that is configured with a second BWP in the carrier; and
receiving, based at least in part on indicating support for independently modifying the BWP configuration of the first communication chain without modifying the second communication chain, an instruction to reconfigure the first communication chain with a third BWP in the carrier without modifying the second communication chain.

22. The method of claim 21, wherein the instruction to reconfigure the first communication chain is based at least in part on a scheduling pattern that includes at least a first time partition that is associated with the first communication chain and a second time partition that is associated with the second communication chain, and
wherein the instruction to reconfigure the first communication chain indicates to reconfigure the first communication chain during at least part of the second time partition.

23. The method of claim 22, further comprising:
reconfiguring the first communication chain to process the third BWP during the at least part of the second time partition.

24. The method of claim 21, wherein the UE capability information indicates a trigger time offset that is associated with independently modifying the BWP configuration of the first communication chain without modifying the second communication chain, and
wherein the method further comprises:
activating a timer that is configured with the trigger time offset based at least in part on receiving the instruction; and
initiating reconfiguration of the first communication chain based at least in part on expiration of the timer.

25. The method of claim 21, wherein the UE capability information indicates support for Type 3 BWP switching that indicates the support for independently modifying the BWP configuration of the first communication chain without modifying the second communication chain.

26. A method of wireless communication performed by a network node, comprising:
receiving user equipment (UE) capability information that indicates support for independently modifying a bandwidth part (BWP) configuration of a first communication chain that is configured with a first BWP in a carrier without modifying a second communication chain that is configured with a second BWP in the carrier; and
transmitting, based at least in part on receiving an indication of the support for independently modifying the BWP configuration of the first communication chain without modifying the second communication chain, an instruction to reconfigure the first communication chain with a third BWP in the carrier without modifying the second communication chain.

27. The method of claim 26, wherein the instruction to reconfigure the first communication chain is based at least in part on a scheduling pattern that includes at least a first time partition that is associated with the first communication chain and a second time partition that is associated with the second communication chain, and
wherein the instruction to reconfigure the first communication chain indicates to reconfigure the first communication chain during at least part of the second time partition.

28. The method of claim 26, wherein the UE capability information indicates a trigger time offset that is associated with independently modifying the BWP configuration of the first communication chain without modifying the second communication chain.

29. The method of claim 26, wherein transmitting the instruction to reconfigure the first communication chain comprises:
transmitting the instruction based at least in part on a scheduling pattern that includes a first time partition that is associated with the first communication chain and a second time partition that is associated with the second communication chain.

30. The method of claim 29, wherein the scheduling pattern includes a time partition that is associated with the second communication chain, and
wherein the instruction indicates to reconfigure the first communication chain during at least part of the second time partition that is associated with the second communication chain.
